(19) United States
(12) Patent Application Publication
(10) Pub. No.: US 2010/0161499 A1
(43) Pub. Date: Jun. 24, 2010

(54) Centralized Rights Management System for Digital Media

(75) Inventors: Scott A. Holcombe, San Diego, CA (US); Joseph Spinney, San Diego, CA (US); Jennifer Bhavnani, San Diego, CA (US)

Correspondence Address: JOHN A. SMART, 201 LOS GATOS, SARATOGA RD, #161, LOS GATOS, CA, 95030-5308, US

(73) Assignee: ROYALTYSHARE, INC., San Diego, CA (US)

(21) Appl. No.: 12/581,092

(22) Filed: Oct. 16, 2009

Related U.S. Application Data
(60) Provisional application No. 61/106,499, filed on Oct. 17, 2008.
(60) Provisional application No. 61/243,903, filed on Sep. 18, 2009.

(51) Int. Cl. G06Q 50/00; G06Q 10/00

(52) U.S. Cl. 705/310

(57) ABSTRACT

A centralized rights management system and methodologies for digital media (e.g., books) is shown and described. In one embodiment, for example, a computer-implemented method is described for automated assertion of a claim of rights in books, the method comprises steps of: maintaining a publicly-searchable registry of books subject to claims by rightsholders; receiving user input allowing a user to select a book from the registry that the user wishes to assert a claim of rights in; displaying a list representing rights that can be claimed by rightsholders for the selected book; receiving input from the user asserting a claim of rights for the selected book; and electronically storing information about the asserted claim of rights, for facilitating automated payments to the user in connection with royalties earned for the selected book.

### CROSS REFERENCE TO RELATED APPLICATIONS

The present application is related to and claims the benefit of priority of the following commonly-owned, presently-pending provisional application(s): application Ser. No. 61/106,499 (Docket No. RS/0004.00), filed Oct. 17, 2008, entitled “Centralized Rights Management System for Digital Media”, of which the present application is a non-provisional application thereof; application Ser. No. 61/243,903 (Docket No. RS/0004.01), filed Sep. 18, 2009, entitled “System and Methodology Providing Book Rights Registry”, of which the present application is a non-provisional application thereof. The present application is also related to the following commonly-owned, presently-pending application(s): application Ser. No. 11/671,220 (Docket No. RS/0001.01), filed Feb. 5, 2007, entitled “Web-based System Providing Royalty Processing and Reporting Services”; and application Ser. No. 12/410,420 (Docket No. RS/0003.01), filed Mar. 24, 2009, entitled “Digital Content Management System with Methodologies for Lifecycle Management of Digital Content”. The disclosures of each of the foregoing applications are hereby incorporated by reference in their entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e):

This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 32494 Bytes, created: Oct. 16, 2009 5:15:52 PM; Object ID: File No. 1; Object Contents: Source code.

### BACKGROUND OF INVENTION

1. Field of the Invention

The present invention relates generally to managing the rights of intellectual property rightsholders and, more specifically, to managing and accounting for rights (and claims thereof), use licenses, and royalties pertaining to digitally stored media content, including books, music, movies, and the like.

2. Description of the Background Art

Traditionally, consumers have purchased media in physical form at retail stores. For example, retail music customers have purchased music by buying physical media at retail stores. After browsing compact discs (CDs) or cassette tapes of interest, the consumer proceeds to a checkout register to pay for the music being purchased. In recent years, however, the Internet has popularized the electronic purchase and delivery of all sorts of media to consumers. Efficient media file formats, such as MP3 (audio) and WMV (video), have made the size of all sorts of digital media assets (i.e., media files) small enough to make their download via the Internet not only practical but highly advantageous.

Today, consumers purchase music, video, electronic book (e-book), and other digital media from online retailers. Many of these retailers started out as “online music stores,” selling music downloads. Examples include Apple iTunes, EMusic, Rhapsody, Napster, Yahoo Music, MSN Music, and MusicMatch, to name a few. Although the digitization of media content was first popularized with music, practically all other media assets—including movies, music videos, educational content, television shows, live events, advertising, literary works, and the like—have been digitized to allow content suppliers to derive revenues from these assets in a digital marketplace. Using an online store, consumers may purchase media content in various forms. For example, music can be purchased either as individual music tracks or in albums of songs, for direct download to one's own computer. When a consumer desires to acquire (e.g., purchase or rent) a media content item (e.g., a digital music file, digital video file, e-book file, or other digital media), the consumer uses a Web-enabled device (e.g., Internet-connected personal computer or cell phone) to communicate with the online service. The service enables the consumer to browse and search for a desired media content item, and download purchased items to the consumer's device. Once stored on the consumer's own device, items can be “played” (i.e., rendered).

Consumer access to media content may be controlled by a variety of methods, depending on the needs of the media service and content owners. For example, downloaded media files themselves may be protected by Digital Rights Management (DRM) encoding, such as Apple Computer's FairPlay encoding, which prevents the playback of purchased media files on unauthorized media players. As another example, Rhapsody offers a subscription plan that allows users unlimited media streaming and burning to CD. More recently, there has been a movement to release content with less protection, such as DRM-free MP3 files available for download (e.g., from Amazon.com). Moreover, some content is available to the public in what is essentially an uncontrolled environment, such as videos posted on YouTube. There, content is often posted by individuals without the permission of the content owner.

Notwithstanding the obvious benefits, digital distribution of media content today is problematic. Given the vast array of digital media content available, the task of accurately tracking the intellectual property rights of various rightsholders has turned out to be a formidable task. Even a single work (e.g., downloaded song) can have multiple rightsholders that require compensation. Furthermore, the problem is compounded by the fact that the task needs to be performed across various multiple disparate domains (e.g., music, books, and videos). Without the accurate tracking of who is selling or using what and when, the owners or rightsholders of digital content are not properly compensated, ultimately hurting the entire marketplace for digital media.

What is needed is a rights management system that can serve as an automated, centralized clearinghouse for digital content. Such a solution should provide a rights management system that leverages understanding of the complexities surrounding media product, rightsholders, use licenses, retailer and publisher relationships, and royalty processing to provide a solution that accurately tracks the intellectual property rights of rightsholders across various domains. The present invention fulfills this and other needs.

### SUMMARY OF INVENTION

A centralized rights management system and methodologies for digital media is shown and described. The digital media may include content such as books (including inserts), music, videos, software, and the like. In one embodiment, for example, a computer-implemented method of the present invention is described for automated assertion of a claim of rights in books, the method comprises steps of: maintaining a publicly-searchable registry of books subject to claims by rightsholders; receiving user input allowing a user to select a book from the registry that the user wishes to assert a claim of rights in; displaying a list representing rights that can be claimed by rightsholders for the selected book; receiving input from the user asserting a claim of rights for the selected book; and electronically storing information about the asserted claim of rights, for facilitating automated payments to the user in connection with royalties earned for the selected book.

In another embodiment, for example, a system of the present invention is described for automated assertion of a claim of rights in books comprises: a publicly-searchable registry of books subject to claims by rightsholders; a selection module for allowing a user to select a book from the registry that the user wishes to assert a claim of rights in; a display module for displaying a list representing rights that can be claimed by rightsholders for the selected book; an assertion module for receiving input from the user asserting a claim of rights for the selected book; and a database storing information about the asserted claim of rights, for facilitating automated payments to the user in connection with royalties earned for the selected book.

### BRIEF DESCRIPTION OF DRAWINGS

FIG. 1 is a very general block diagram of a computer system (e.g., an IBM-compatible system) in which software-implemented processes of the present invention may be embodied.

FIG. 2A is a high-level block diagram illustrating the architecture of the rights management system of the present invention, with specific emphasis on its use by music publishers.

FIG. 2B is a block diagram of the rights management system of the present invention with specific emphasis on its use by book publishers.

FIG. 2C is a block diagram of the rights management system of the present invention configured to operate with an optional security compliance module (monitor).

FIG. 2D is a block diagram of the rights management system of the present invention with specific emphasis on its use by Movie and Television studios.

FIG. 2E is a block diagram of the rights management system of the present invention with specific emphasis on its use by Record Labels.

FIG. 3 is a high-level flowchart summarizing the overall method involved in using the Book Rights Registry (BRR) system of the present invention.

FIG. 4 is a high-level block diagram illustrating the major components of the BRR system of the present invention.

FIG. 5 is a block diagram showing the general navigation of a Web site constructed in accordance with the present invention.

FIG. 6A is a bitmap screenshot illustrating a Home Page (Web page) constructed in accordance with the present invention.

FIG. 6B is a bitmap screenshot illustrating a Register Web page constructed in accordance with the present invention.

FIG. 6C is a bitmap screenshot that illustrates an input screen for creating a new Author account.

FIG. 6D is a bitmap screenshot that illustrates an input screen for creating a new Publisher account.

FIG. 7A is a bitmap screenshot illustrating a Book Rights Registry (BRR) Page (Web page) constructed in accordance with the present invention.

FIG. 7B is a bitmap screenshot illustrating a Search Registry Page (Web page) constructed in accordance with the present invention.

FIG. 8A is a bitmap screenshot illustrating search results (Web page) of the search started on the opening page.

FIG. 8B is a bitmap screenshot illustrating the search results (Web page) maximized, that is, with the Search for books panel closed.

FIG. 8C illustrates icons employed to represent claims.

FIGS. 9A-E are bitmap screenshots illustrating the process of claiming a book.

FIG. 10A is a bitmap screenshot illustrating a Book detail view or page, where the user can view details of each book.

FIG. 10B is a bitmap screenshot illustrating collection assignments for a book.

FIG. 10C is a bitmap screenshot illustrating completion of edits, for a registered book.

FIG. 10D is a bitmap screenshot illustrating the user interface when the book is in dispute between Rightsholders.

FIG. 10E is a bitmap screenshot illustrating the user interface when a registered user (author) has added a book to the Registry that did not appear after performing a search for the book.

FIG. 10F is a bitmap screenshot illustrating email notification sent to the user if something that appears to match is added.

FIG. 10G is a bitmap screenshot illustrating a View History page.

FIG. 10H is a bitmap screenshot illustrating a page providing a view for suggested matches from Registry.

FIG. 10I is a bitmap screenshot illustrating a confirmation page, asking the user to confirm an “un-match.”

FIG. 10J is a bitmap screenshot illustrating use of a “Compare to Original” column.

FIG. 10K is a bitmap screenshot illustrating the user interface for adding a book that is not in the Registry (e.g., when not found during a search).

FIG. 10L is a bitmap screenshot illustrating updating of the user interface to indicate “Book Successfully Added.”

FIGS. 11A-F are bitmap screenshots illustrating the process of importing book data.

FIGS. 12A-F are bitmap screenshots illustrating the process of importing a “binary” (i.e., electronic file) that is to be associated with a registered book.

FIG. 13 is a high-level block diagram illustrating a method for registering/claiming a book using the book rights registry system of the present invention.

FIGS. 14A-B comprise a high-level block diagram illustrating a method for processing and distributing payments for books and other items registered with the book rights registry system of the present invention.

### DETAILED DESCRIPTION

Glossary

The following definitions are offered for purposes of illustration, not limitation, in order to assist with understanding the discussion that follows.

Digital Advantage™: RoyaltyShare Digital Advantage™ Service, which compiles and aggregates incoming data from digital sales channels.

ISRC: Abbreviation for International Standard Recording Code, which is the international identification system for sound recordings and music videorecordings. Each ISRC is a unique and permanent identifier for a specific recording that can be permanently encoded into a product as its digital fingerprint. Encoded ISRC provide the means to automatically identify recordings for royalty payments.

Label (Record Label): Shorthand used to refer to a content owner, such as a Record Label (e.g., EMI).

Label Advantage™: RoyaltyShare Label Advantage™ Service, which is optimized for calculating and processing royalties for the digital and physical worlds. The service provides Record Labels with a Web-based system to simplify the process of generating and reporting royalties to artists, publishers and songwriters.

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Rightsholder (or, “rights holder”): Individual (e.g., author) or entity (e.g., publisher) that holds certain rights (e.g., intellectual property rights, including without limitation copyright rights) in one or more works (e.g., book or other literary work protected under copyright law and international treaties).

UPC: Stands for Universal Product Code, which is one of a wide variety of bar code languages called symbologies. The UPC was the original barcode widely used in the United States and Canada for items in stores.

UGC: UGC is an abbreviation for User Generated Content. This is end-user created content which typically consists of video and audio elements, some of which may be the intellectual property of existing rightsholders. This is typical of content uploaded to social networking sites such as YouTube, MySpace and Facebook.

URL: URL is an abbreviation of Uniform Resource Locator, the global address of documents and other resources on the World Wide Web. The first part of the address indicates what protocol to use, and the second part specifies the IP address or the domain name where the resource is located.

Work(s): Refers generally to items subject to copyright and other intellectual property rights, including for example audiovisual works, literary works, musical works, dramatic works, pictorial and graphic works, motion pictures and other audiovisual works, and sound recordings.

XML: XML stands for Extensible Markup Language, a specification developed by the World Wide Web Consortium (W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations. For further description of XML, see e.g., “Extensible Markup Language (XML) 1.0”, (2nd Edition, Oct. 6, 2000) a recommended specification from the W3C, the disclosure of which is hereby incorporated by reference. A copy of this specification is available via the Internet (e.g., currently at www.w3.org/TR/REC-xml).

### Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

### Computer-Based Implementation

Basic System Hardware and Software (e.g., for Desktop and Server Computers)

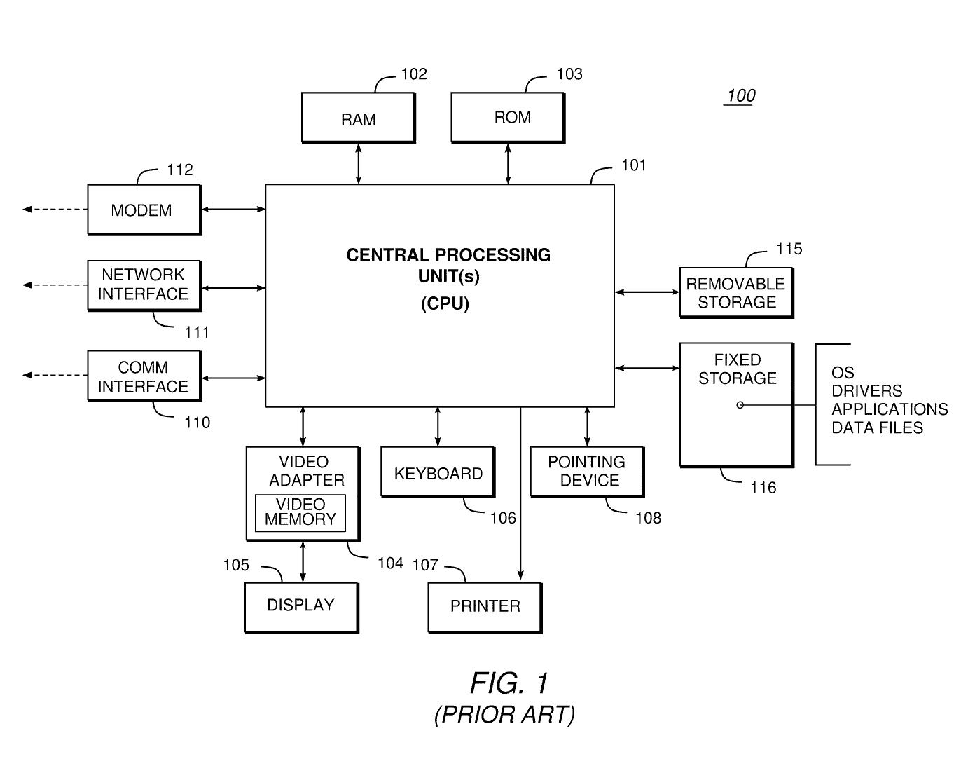

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP LaserJet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying desktop and server computer components that may be employed for implementing the present invention. For purposes of discussion, the following description will present examples in which it will be assumed that there exists a “server” (e.g., Web server) that communicates with one or more “clients” (e.g., desktop computers, from which users log on to the server in order to use services). The present invention, however, is not limited to any particular environment or device configuration. In particular, a client/server distinction is not necessary to the invention, but is simply a suggested framework for implementing the present invention. Instead, the present invention may be implemented in any type of system architecture or processing environment capable of supporting the methodologies of the present invention presented in detail below, including implementing the methodologies on a standalone computer (i.e., where users log on to the same computer that the computer-implemented methodologies are serviced). Additionally, the following description will largely focus on music and book content (e.g., digitally stored music files and books) in order to simplify the discussion. However, those skilled in the art will appreciate that the system and methodologies of the present invention may be advantageously applied to rights management for all types of content.

### Centralized Rights Management

Overview

The present invention comprises a rights management system for digital media. The system enables record companies, music and book publishers, authors, television and movie studios, and other rightsholders to license and track rights for their works in the digital marketplace. The system specifically solves the problem of helping users or firms consuming or selling digital content to properly pay for the use of intellectual property attendant to that content, so that the appropriate rightsholder may be compensated in an easy and appropriate manner.

Consider the following problem. YouTube.com streams video to end users. Many of the videos are uploaded by individuals, with little or no accounting as to origin or ownership. YouTube (now owned by Google) asserts that it would gladly pay the rightsholder, but it cannot figure out who the right holders are most of the time. Thus currently, a substantial amount of content is consumed on YouTube without any compensation paid to the underlying owners. Simply put, every service or content distributor cannot actively keep track of who owns what, given the thousands upon thousands of rightsholders that may be involved. The present invention solves this problem by providing a platform that facilitates the coming together of content distributors or providers (e.g., YouTube) and content owners or publishers (e.g., Viacom), so that the appropriate rightsholder can be paid. The foregoing represents but a single instance of a much broader problem. Stated generally, there is a need for a system that easily allows any party selling media (e.g., music, books, video, etc.) to compensate the appropriate right holders (e.g., performers, writers, producers, publishers, etc.).

The challenges to solving such a problem are nontrivial. Even if one could locate the appropriate rightsholders, current approaches do not afford any practical mechanism to track rightsholders over a period of time. For a given work, publishing rights may change over time, for example due to transfers between music publishers (which do not even involve content sellers). Rightsholders themselves also face challenges tracking content that they have rights in. Each major Record Label, for instance, has a sizable catalog of works and thus managing rights in the catalog itself becomes a challenge. Therefore, it is equally difficult for rightsholders to keep pace with change and growth in digital use of their material. The rightsholders would prefer an approach that affords more direct visibility into the rights of individual works that a given holder owns.

The foregoing problem raises other issues. Currently, music publishers occupy a relatively unattractive lower tier in the payment hierarchy. For example, sellers of downloaded music pay Record Labels, which in turn pay the publishers. For streaming music, publishers are frequently unpaid. The current approach has turned out to be one that is not in the publisher's best interests. The approach does not lend itself to accountability or control, with music publishers being relegated to a lower tier of payment priority. What is needed for music publishers is a system that allows them to better track and manage rights, thus ensuring that songwriters and publishers receive their fair share of income from on-line music subscription services that provide interactive streaming. Such a system enables music publishers to directly receive their royalties for full-length digital downloads in the future.

For Record Labels, the system enables record companies to more effectively and efficiently manage their catalog of recorded music in the digital marketplace. Rather than having to work with each store individually, they can work with a single entity to manage deal terms, changes in ownership, income collection, and validation. This facilitates the transfer of ownership of a catalog from one Record Label to another, so that the current approach of manually taking down and reposting content is eliminated. In particular, the underlying rights of the rightsholder are transferred in a transparent manner, akin to the simplicity of a domain (website) transfer. The new owner is appropriately compensated, all without the need to repackage or re-post content.

The rights management system of the present invention is particularly useful for uncontrolled usage models of content distribution, such as YouTube or peer-to-peer (P2P) networks. In contrast to controlled usage models such as iTunes where content available for distribution is licensed, an uncontrolled usage model essentially has no facility whatsoever for tracking or compensating rightsholders. With YouTube, for example, users typically post content of unknown origin, at least until some point in time when it is identified. Even when such content is identified, it typically is unlicensed and its rightsholder may be unknown. Therefore, there is a need for rightsholders to have a mechanism to allow their content to be distributed in uncontrolled manner, including user-uploaded usage models, so that such content may be properly identified and compensated. The system of the present invention facilitates this identification of content and the use license available from underlying rightsholders, and thus facilitates proper compensation to those parties.

The rights management system of the present invention also allows Record Labels to regain control over works in their catalog. For example, a common problem today is that Record Labels do not have a ready means to maintain control over pricing of individual works. The upshot of this problem is that Record Labels have more or less had to accept terms dictated by the vendors, such as iTunes. Using the rights management system of the present invention, Record Labels can reassert control over the terms (i.e., “use terms”) that their works are available. For example, a Record Label can effect terms by which its works are made available to iTunes or any other online vendor. In this example, the content owner (e.g., Record Label) is able to control the terms of use under which he expects to be paid (i.e., the wholesale price), and the retailers in turn set retail pricing however they see fit (even accepting a loss for particular content if they choose to do so). For its part, a given vendor may or may not agree to abide by such terms. If a given vendor does not agree, then it of course does not get the right to sell copies of the work. Importantly, the individual Record Label regains control over use terms for works in its catalog so that it can set terms that are consistent with a sustainable business model, as opposed to the current environment where vendors sell copies for whatever they want. This provides Record Labels with an easy mechanism to, for instance, sell a tune for $1.65 notwithstanding a given vendor's insistence of selling all tracks at $0.99. Only those vendors agreeing to the term of $1.65 per copy received the right to sell copies.

The benefits of the present invention are applicable to all kinds of digital media owners. For Motion Picture and Television Studios, the rights management system of the present invention enables video content owners to effectively manage and collect retail and ad revenue based income for the use of their works in the constantly evolving on-line digital landscape. For Book Publishers, the system provides publishers an effective means to oversee and receive income for e-books and evolving digital versions and derivations of their works. The system accommodates and reflects whatever is sold digitally and whatever right holders rights are being represented, so that the rightsholders can obtain the compensation that they are entitled to.

### System Components

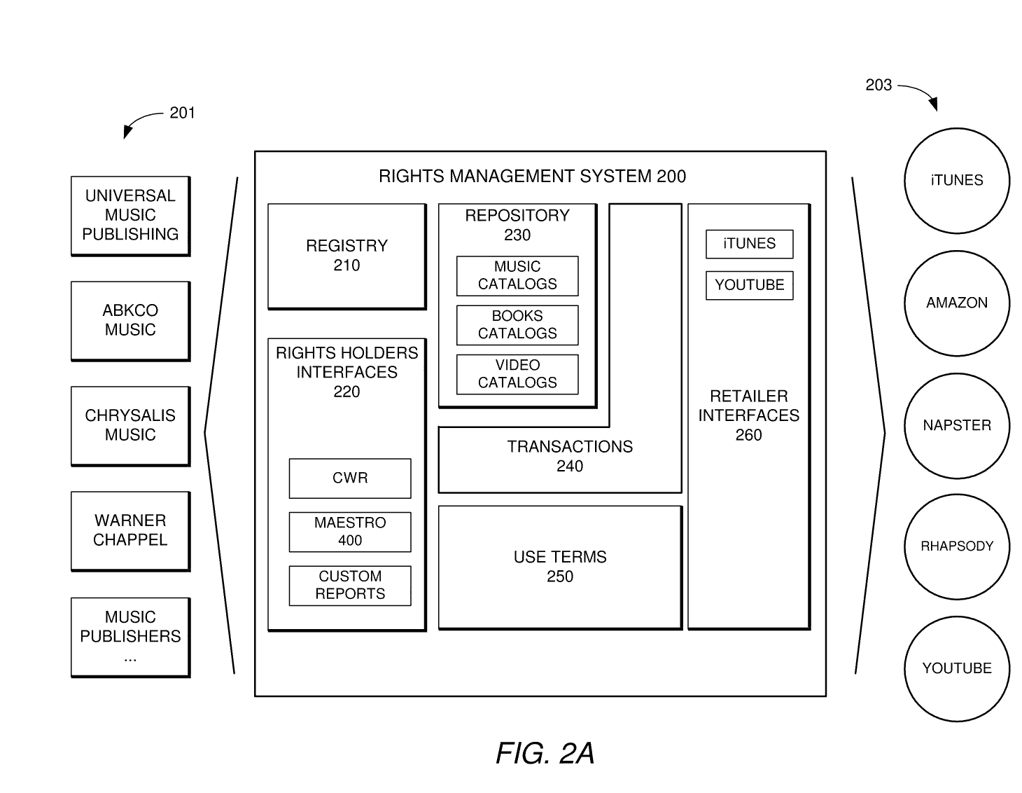

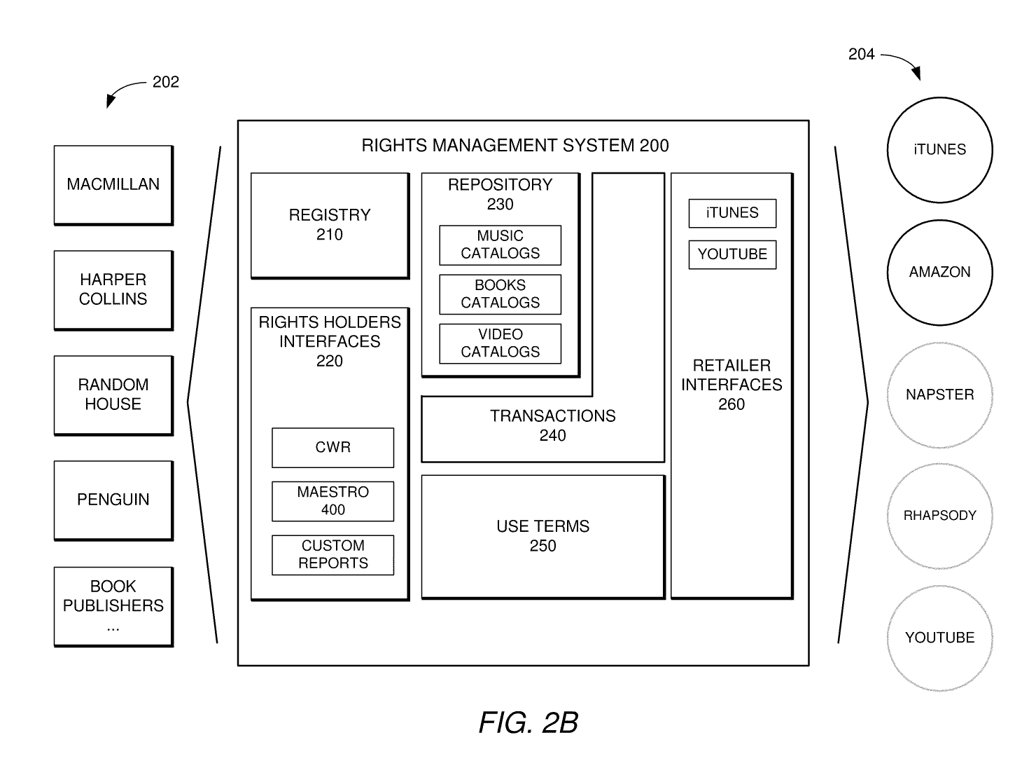

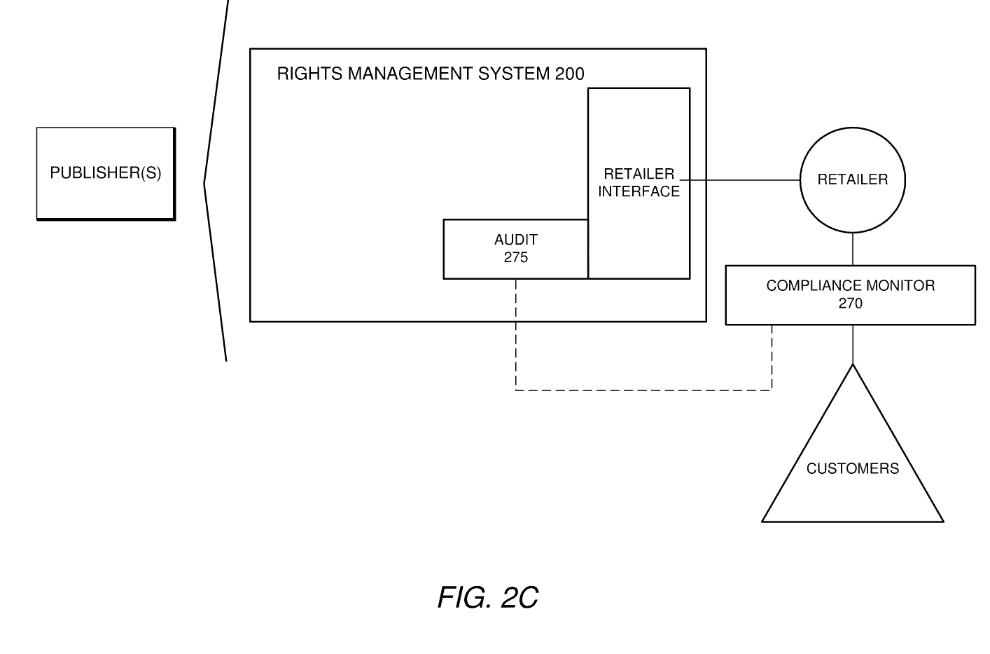

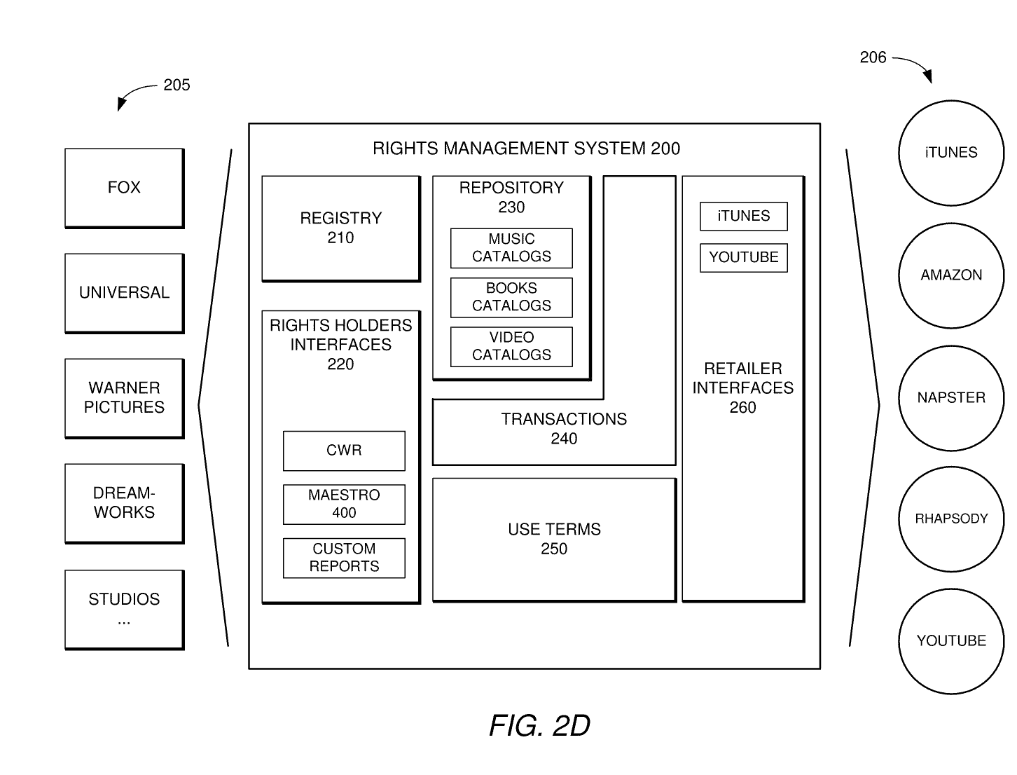

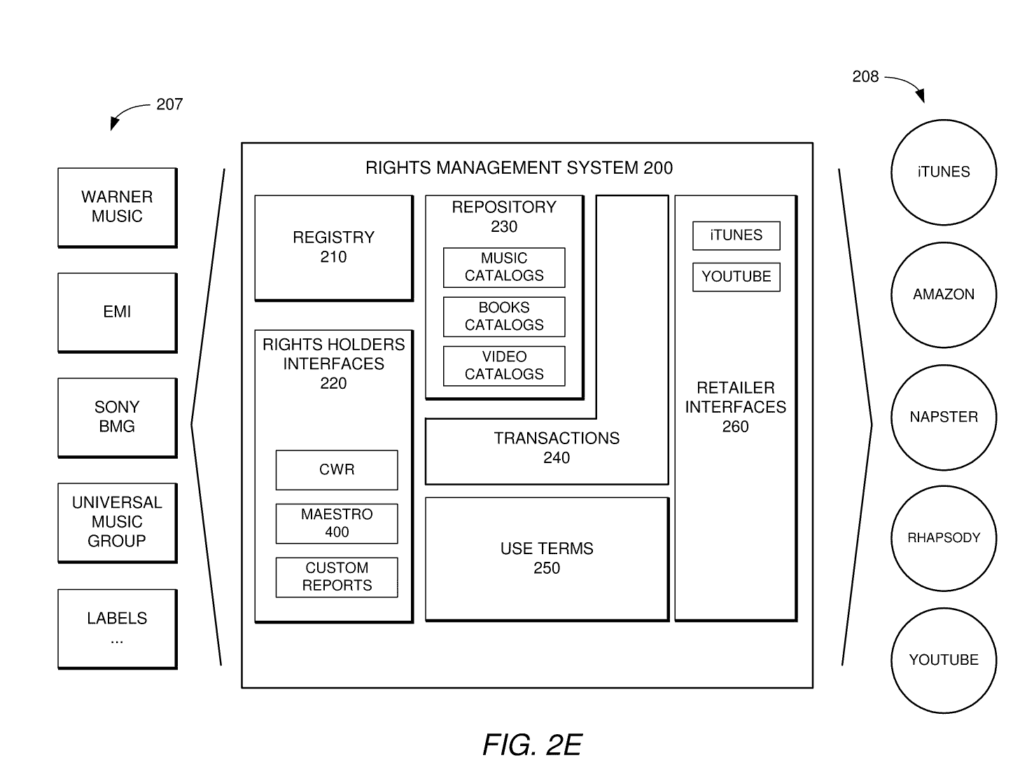

FIG. 2 is a high-level block diagram illustrating the architecture of the rights management system of the present invention. Rightsholders are represented on the left-hand side of the diagram, and retailers/vendors are shown on the right-hand side. As shown, the rights management system 200 includes a Registry 210, Rightsholders Interfaces 220, a Repository (Catalogs) 230, a Transactions module 240, a Use Terms (License) module 250, and Retailer Interfaces 260. As shown, the system interacts with Rightsholders 201 (e.g., music publishers) and Content Retailers/Providers 203 (e.g., on-line stores and on-line content providers).

The Registry 210 is the component that verifiable rightsholders can be registered with and tracked by the system. Note that it is not permissible just to register any party or individual as a rightsholder, since such a lax approach invites fraud. Instead, rightsholders must present verifiable credentials (e.g., Dunn and Bradstreet numbers) together with a (nominal) processing fee, in order to authenticate rightsholders and maintain the integrity of the Registry 210. Once properly authenticated, a rightsholder may begin to manage its rights and receive royalty income streams.

The Repository 230 comprises one or more Catalogs, including for instance Music Catalog(s), Books Catalog(s), and Video Catalog(s). Each catalog tracks all of the available goods in a given category (i.e., represents goods for sale). Note that it is not necessary to track everything that may possibly be sold. Instead, it is only necessary to track those things that are actually sold—that is, things that actually receive an income stream. Accordingly, each catalog is maintained to reflect items actually sold. Starting with a root catalog, such as MetaBrainz (a user-maintained, Gracenote-style community music metadatabase operated by the MetaBrainz Foundation of San Luis Obispo, Calif.), a given catalog may be maintained by actively monitoring Web storefronts (e.g., iTunes) and/or uncontrolled websites (e.g., YouTube). Other sources for the root catalog include Amazon's SoundUnwound (which provides a Wikipedia-style site allowing users to edit information about any band, label, album or song) and/or commercially licensed sources such as Gracenote and the Internet Movie Database (IMDb). Each type of product is modeled as it is sold in the real world (i.e., as a music product, book product, and so forth). The amount of information tracked need only be that sufficient to establish rights, for instance, music (album/tracks), books (titles/chapters), video (movies, TV series/episodes, UGC).

As shown, the system includes Rightsholders Interfaces 220 which provides hooks to appropriate rightsholders/interested parties to make corrections to the Repository. Through this interface, rightsholders (e.g., music publishers) may enter information directly into the catalogs using standards-based metadata/data input, including support for actual standards (CWR—common works registration) and de-facto ones (Maestro 400). The rights for a given work may be shared among multiple parties, whereupon the entry into the catalog indicates multiple rightsholders.

The Use Terms module 250 manages license terms for how rightsholders require to be paid, that is, provides instructions on how content is to be used and therefore paid for by retailers on the front end. For example, a record label may specify a term that requires retail vendors to pay $0.70 for each copy of a song that is downloaded. Here, the record label may specify that the term is mandatory. In that case, any vendor seeking to offer the song for retail download must pay $0.70 per copy (i.e., it must abide by that term) or it cannot use the song. If the vendor's retail price is insufficient to cover that amount, then the vendor must make up the difference (e.g., through ad revenue) if it wishes to use the song for download retail.

The Transactions module 240 is the main processing engine for processing all transactions that flow through the system, matching incoming sales transactions against products, and in turn against applicable use terms. In the currently preferred embodiment, the Transactions module 240 may be implemented using RoyaltyShare's Royalty Processing and Reporting Services, as described in currently pending, commonly-owned application Ser. No. 11/671,220, filed Feb. 5, 2007, titled Web-based System Providing Royalty Processing and Reporting Services, the disclosure of which is hereby incorporated by reference. To better accommodate the needs of rightsholders, the system 200 includes Retailers Interfaces 260 to support third-parties, allowing authorized third parties to provide import and/or processing capability. Ultimately, the transactions will flow back to the rightsholders in the form of royalty payments. Additionally, transactions are reported back to the rightsholders using standard reports and (depending on the rightsholder) custom reports.

The block diagram of FIG. 2A shows the rights management system of the present invention configured with specific emphasis on its use by music publishers. In the music space (i.e., music and video products), the full complement of system components is employed. Typical retailers include Napster, Rhapsody, and YouTube. In this configuration the system facilitates direct payment to the music publishers, including Warner Chappell Music, Universal Music, and so forth. This is an important advantage for music publishers when dealing with Record Labels. Although one may assume that a given Record Label would pay the appropriate music publisher in a timely fashion, in reality however such payments occur at a glacial pace (e.g., tying up a year's worth of royalty payments in float accounts). Here, the Record Labels lack motivation to allocate significant resources to address the issue. With the system of the present invention, however, rightsholders such as music publishers can stake their claim to various works and expect payment in a timely manner, using the features of the present invention to facilitate determination and payment of royalties for various works.

FIG. 2B is a block diagram of the rights management system of the present invention with specific emphasis on its use by book publishers (202), including MacMillan, HarperCollins, Random House, and so forth. Typical retailers (204) include Amazon, iTunes, and so forth. In this configuration the system facilitates direct payment to the book publishers. Note that not every rightsholder has product at every retailer or store. However that is not important, as matching a retailer's sale of a product to a given publisher is handled automatically by the system. Apart from use of the system with downloadable e-books, the system is well adapted to implementing a usage model that handles royalty events that occur in connection with Web-based viewing of scanned books (e.g., Google Books). With this usage model, the user pays for bits or portions of the work (e.g., per page, per chapter, per view, or so forth). With the system of the present invention, those individual bits may be tracked back to the underlying work, and thus the royalty payments due the rightsholder may also be determined.

As shown in FIG. 2C, an optional compliance monitor 270 may be added at the front end (e.g., of the retailer) to ensure compliance with the rightsholder's usage terms. This security piece provides an audit function: the royalties ultimately reported by the retailer or purveyor of the content are reported to an audit module 275 of the system 200, thus allowing those royalties to be matched up against consumption activity already observed (by the front end security or compliance monitor 270). Use of the compliance monitor 270 may be dictated by usage terms tracked in the system, including giving a discount royalty rate for those retailers using the module. In this manner, the compliance module can detect and prevent fraud.

FIG. 2D is a block diagram of the rights management system of the present invention with specific emphasis on its use by Movie and Television studios (205), including 20th Century Fox, Universal, and so forth. Typical retailers (206) include Amazon, iTunes, YouTube, and so forth. In this configuration the system includes the ability to restrict use unless fair market value is paid to the studios.

FIG. 2E is a block diagram of the rights management system of the present invention with specific emphasis on its use by Record Labels. The Record Labels (207), such as EMI, Warner, Sony, and the like, have existing business and technology relationships with retailers (208) including Amazon, iTunes, Napster, Rhapsody YouTube, and so forth. In this configuration the system provides an improved infrastructure that facilitates transactions between the retailers and the Record Labels. In effect, the system provides an automated clearinghouse for the participants so that no one party need craft one-off licensing solutions. In contrast to existing (manual) clearing houses (e.g., ASCAP) which use rough statistical base approaches to calculating royalties, the approach of the present invention allows calculations based on actual use so that the precise amount actually due can be determined in real time. The data is collected in real time. Thus, it may be used for valuable data mining purposes and analysis, such as for determining effectiveness of ad campaigns.

### Book Rights Registry System and Platform

Introduction

In 2004 Google launched what became known as Google Book Search—“an enhanced card catalogue of the world's books”—and began digitizing the collections of several libraries and universities, including Oxford and Harvard. Authors and publishers filed a class action lawsuit, claiming Google violated the copyrights of authors, publishers and other copyright holders (i.e., “rightsholders”) by scanning in-copyright books and “inserts” (other text and material, including for example sheet music), and displaying excerpts, without permission. The parties agreed to a settlement, referred to generally as the Google Settlement or simply the Settlement. The Settlement (if Court-approved) will authorize Google to scan in-copyright books and inserts in the United States, and maintain an electronic database of books. For out-of-print books, and if permitted by rightsholders of in-print books, Google will be able to sell access to individual books and institutional subscriptions to the database, place advertisements on any page dedicated to a book, and make other commercial uses of books. At any time, rightsholders can change instructions to Google regarding any of those uses. Through a registry (Google Book Rights Registry) established by the settlement, Google will pay rightsholders 63% of all revenues from these uses.

In accordance with the present invention, a Book Rights Registry (BRR) platform is provided that is an embodiment of the centralized rights management system for digital media assets subject to the Google Settlement. The BRR platform enables: Rightsholders to make sense of the Google Settlement and ongoing industry activity in an easy-to-use platform; interested parties to stay up to date as their world of books evolves; and the Registry to carry out necessary tasks as determined in the Settlement.

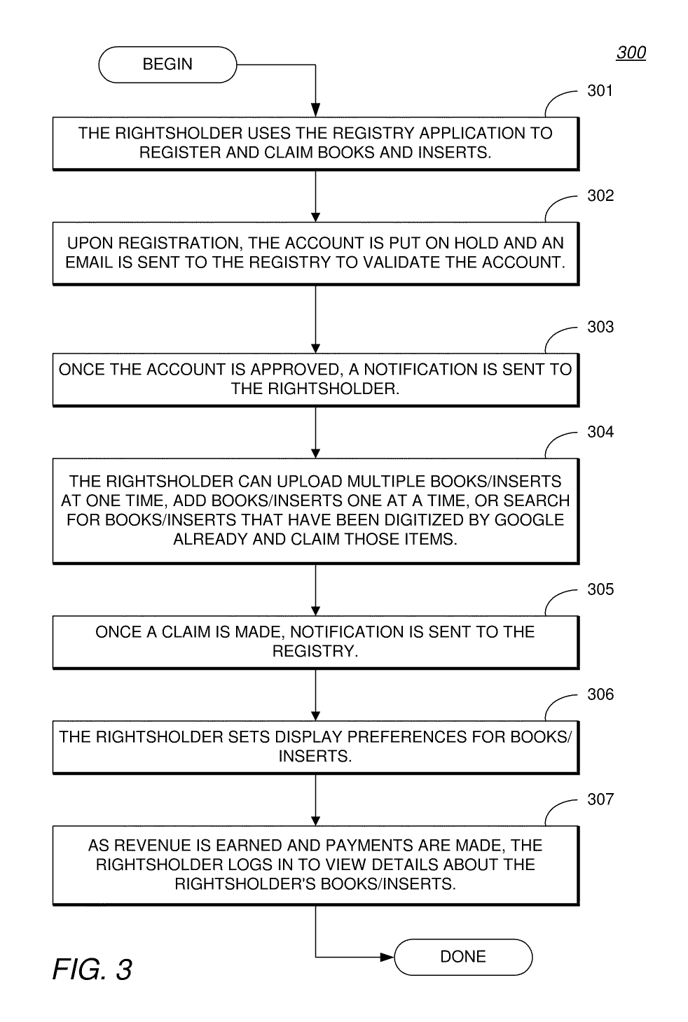

FIG. 3 is a high-level flowchart summarizing the overall method 300 involved in using the BRR platform. At step 301, the rightsholder uses the BRR platform and its Registry application to register and claim books and inserts. Upon registration, the account is put on hold and an email is sent to the Registry to validate the account, as shown in step 302. Once the account is approved, at step 303, a notification is sent to the rightsholder. The rightsholder can upload multiple books/inserts at one time, add books/inserts one at a time, or search for books/inserts that have been digitized by Google already and claim those items, as indicated in step 304. Once a claim is made, notification is sent to the Registry, at step 305. At step 306, the rightsholder sets display preferences for books/inserts. As revenue is earned and payments are made, at step 307, the rightsholder can log in and view details about his/her books/inserts.

User Personas

“Author” (sub-class): means members of the Settlement Class who are authors, and their heirs, successors and assigns, and any other members of the Settlement Class who are not members of the Publisher Sub-Class.

“Publisher” (sub-class): means members of the Settlement Class that are (a) companies that publish books, and their exclusive licensees, successors and assignees, and (b) companies that publish Periodicals and have a Copyright Interest in one or more Inserts, and their exclusive licensees, successors, and assignees.

User Persona #1: Rightsholders Including those in the Author Sub-Class and the Publisher Sub-Class

### Goals:

Claim books and inserts
View earned and received revenue
Manage conflicts in ownership
Interact with the Registry to obtain help

### Problems:

The Google Settlement provides $34.5 million dollars that must be paid to the Rightsholders of books and inserts that have been scanned and those Rightsholders must be able to claim ownership of their content.
Rightsholders must also have a way of receiving payments from Google/the Registry

### Use Scenarios:

Rightsholders will log in to the application and claim books and inserts. As long as there isn't a conflict in ownership, they are able to claim the book/insert.
Once rights are claimed, Rightsholders can view their “catalog,” monitor payments and usage, and follow ongoing activity in the industry.

User Persona #2: BRR Administrators

### Goals:

Approve Rightsholders
View Rightsholders that have signed up
Easily see which ones should be verified and approved
Interact with Rightsholders when assistance is needed
View activity of Rightsholders
Interact with Google
Monitor payments to Rightsholders

### Problems:

Money must be paid from the Registry to the Rightsholders
There are millions of Rightsholders that must be able to claim millions of books

### Use Scenarios:

Rightsholder will call/email/chat and ask for assistance
Registry must be able to view that Rightsholder's information and assist with the question at hand
Rightsholder will submit an “application” that must be approved.
Registry must view the Rightsholder applicant, do research offline, and then either approve or disapprove the Rightsholder
Administrator will want to view analytical reports on various things;
Number of Rightsholders signed up
Number of books/inserts claimed
Outstanding payments owed
Payments made

User Persona #3: Google Administrators

### Goals:

View activity
Interact with the Registry
Obtain data from the Rightsholders including claims and display settings

### Problems:

Google must be able to obtain the information that Rightsholders provide including claimant information and display preferences for books and inserts

### Use Scenarios:

Administrator will log in to an admin interface to view analytics
Administrator will log in to view specific rights
Automated processes will transfer claim information and display preferences to Google

### BRR Components

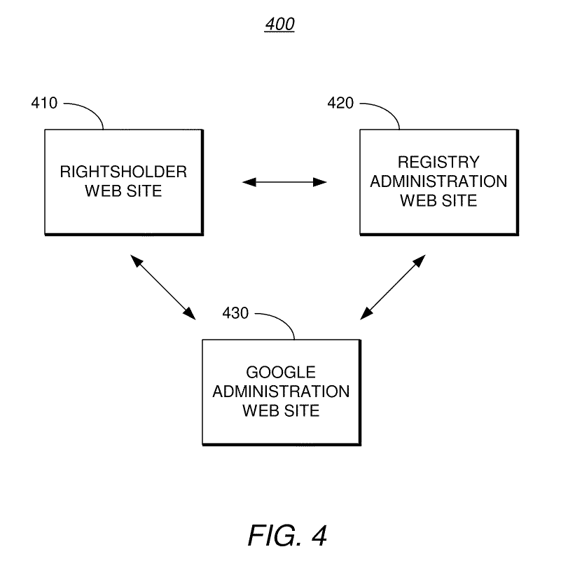

FIG. 4 is a high-level block diagram illustrating the major components of the BRR platform of the present invention. As shown, BRR platform 400 includes a Rightsholder Web Site 410, a Registry Administration Web Site 420, and a Google Administration Web Site 430. The Rightsholder Web Site 410 is a database-driven Web site for users to register, claim books and inserts, and manage rights. The Registry Administration Web Site 420 is a database-driven Web site for administrators to interact with users and Google, monitor usage, and generate reports. The Google Administration Web Site 430 is a Web site for Google administrators to interact with the Registry, generate reports, and monitor usage.

### User Interface (UI)

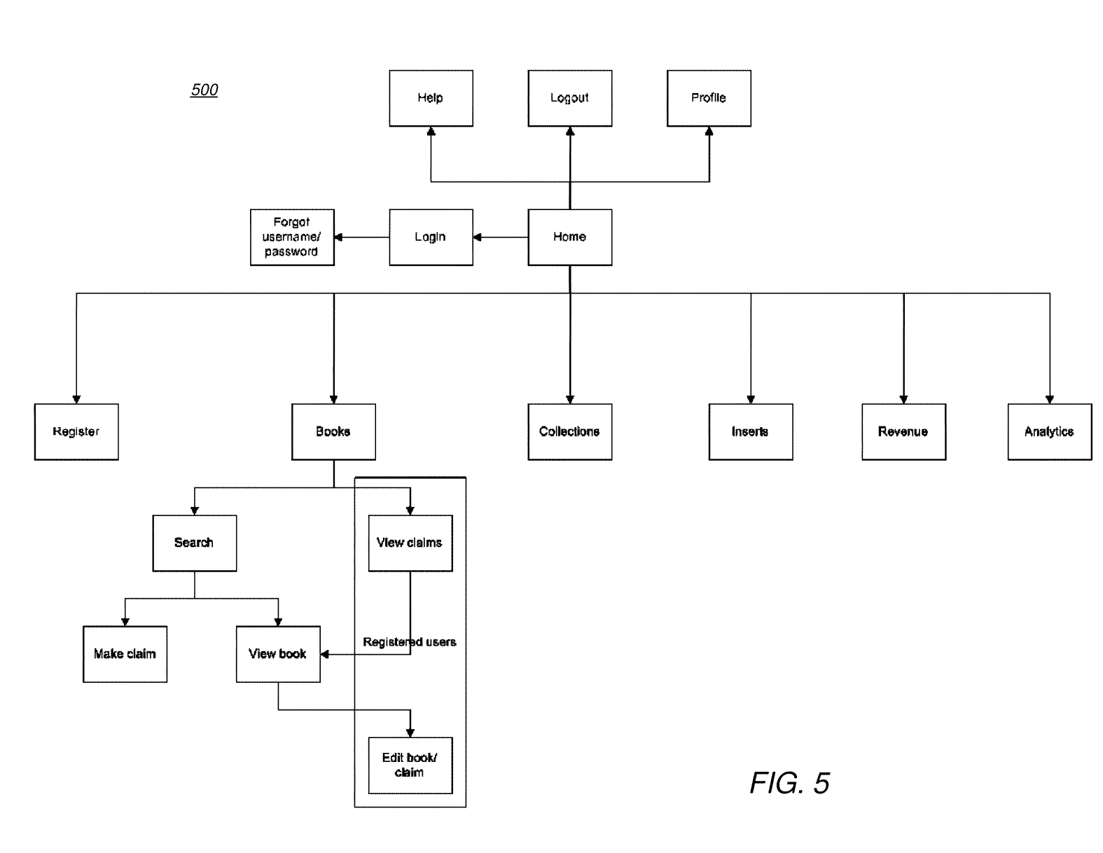

FIG. 5 is a block diagram 500 showing the general navigation of a Web site constructed in accordance with the present invention. Of particular interest herein are the following user interface elements.

The Home Page

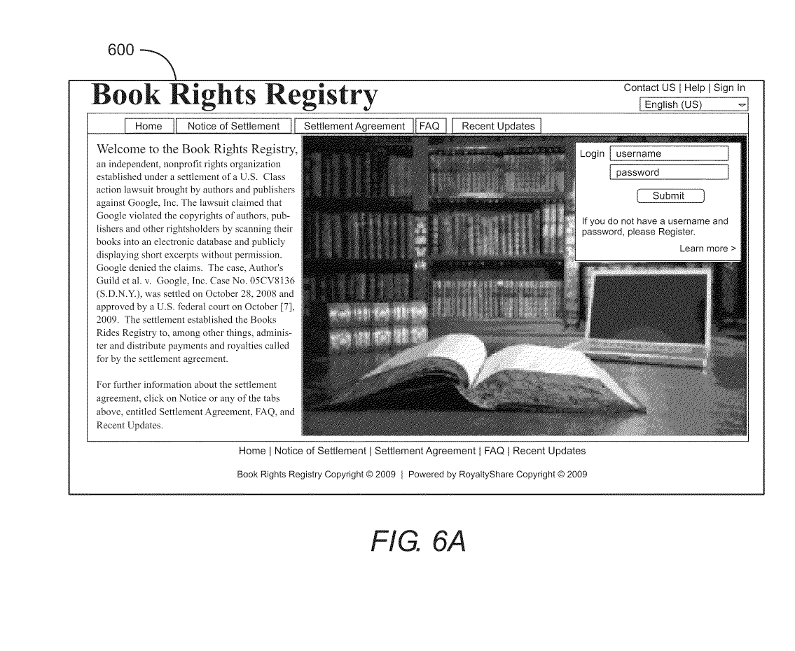

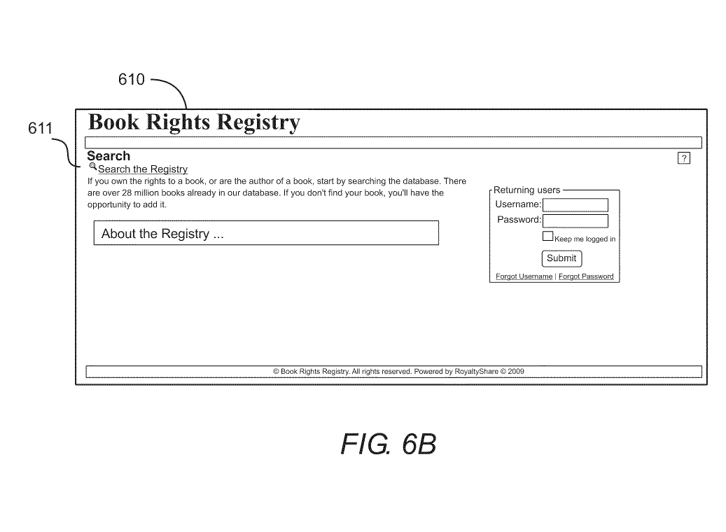

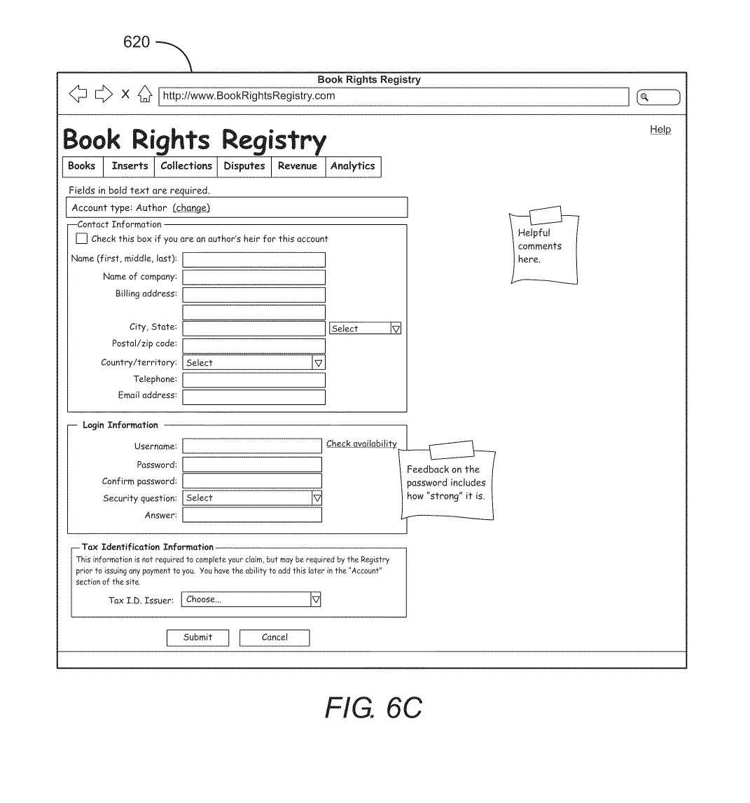

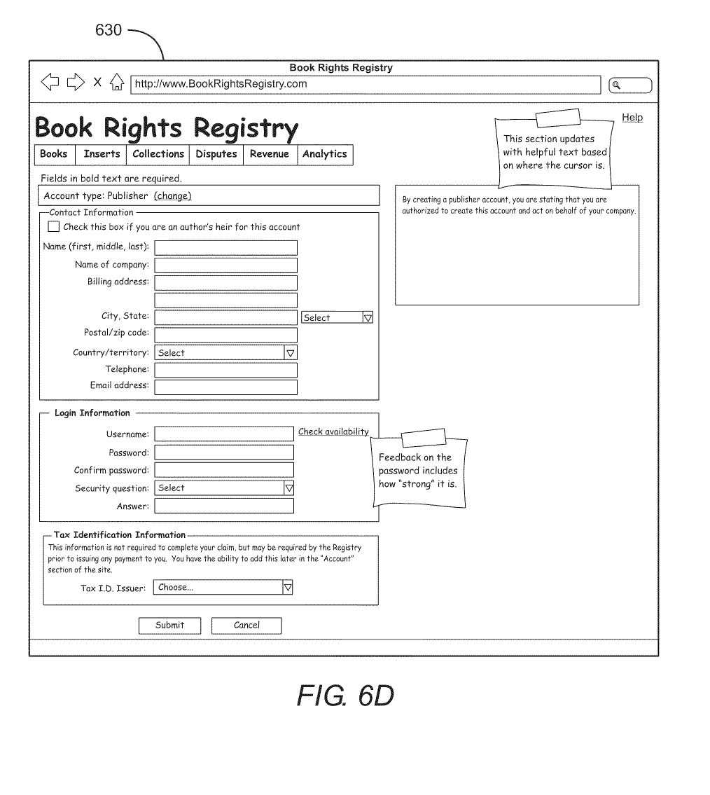

FIG. 6A is a bitmap screenshot illustrating a Home Page (Web page) constructed in accordance with the present invention. The Home Page 600 introduces the visitor to the Book Rights Registry. From the Home Page 600, the user can choose to either log in as a “Rightsholder,” or view information intended for the general public (i.e., publicly-searchable Registry). The Home Page may be customized to support a particular brand.

Register

FIG. 6B is a bitmap screenshot illustrating a Register Web page 610 constructed in accordance with the present invention. Register page 610 displays Username and Password input fields, which receive input of that information for logging into the system, in a conventional manner. For example, Usernames are unique names assigned to identify users. In the current embodiment, these are preferably not email addresses because someone may have an author account and a publisher account (i.e., multiple accounts are supported). All user types have the ability to add other users and have multiple user accounts. If someone chooses only to have one account, a “master account” is created on the backend (with the user's knowledge). Users have the option of adding other users at any time. As also shown, the page 610 includes a search link 611, which permits searching of the Registry database (e.g., by author, title, ISBN, and the like). FIG. 6C is a bitmap screenshot that illustrates an input screen 620 for creating a new Author account. FIG. 6D is a bitmap screenshot that illustrates an input screen 630 for creating a new Publisher account.

### Books Section

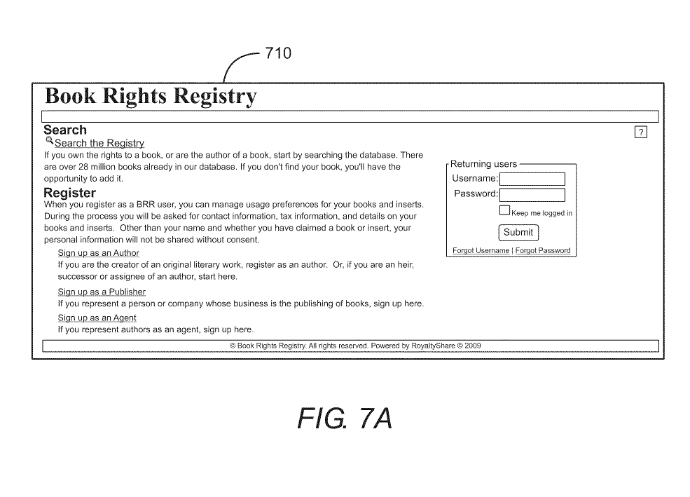

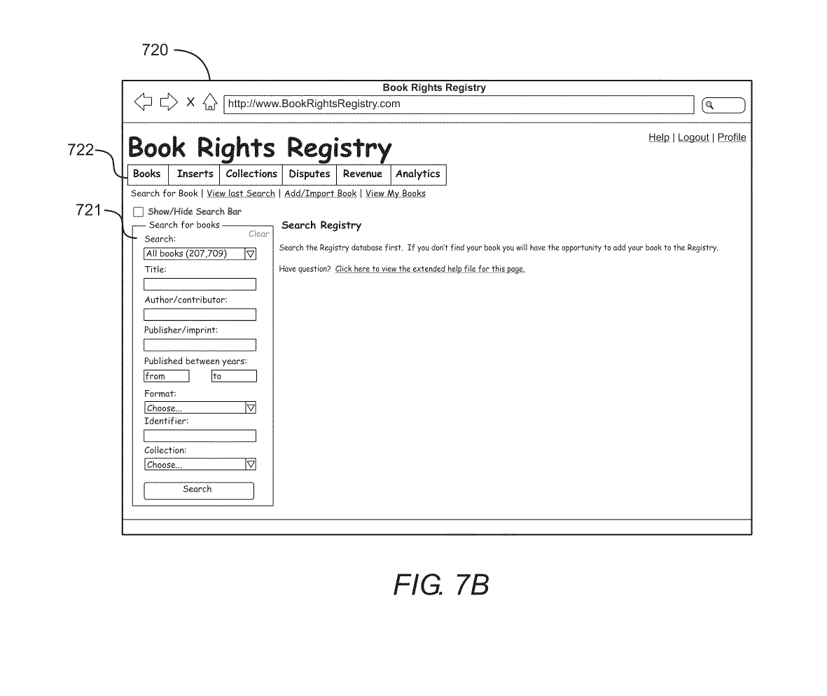

FIG. 7A is a bitmap screenshot illustrating a Book Rights Registry (BRR) Page (Web page) 710 constructed in accordance with the present invention. The BRR Page 710 presents a Books Section, which is where the majority of the action occurs in the BRR's Registry application. From here, users can search for books, make claims, and manage usage preferences. Non-rightsholders can search and view books as well.

FIG. 7B is a bitmap screenshot illustrating a Search Registry Page (Web page) 720 constructed in accordance with the present invention. This page is the default screen for all users, and allows them to search the publicly-searchable Registry. Once the user logs in, this is where they are taken. The left side of page provides a Search for books panel or bar 721. The panel 721 includes the following criteria:

### Search:

Unmatched books (of “my” books): Number of books in parentheses

Matched books (of “my” books): Number of books in parentheses

All my added books: Number of books in parentheses

Registry only: Number of books in parentheses
Title: Similar results will be found. Quotation marks used to find an exact match.
Author/contributor: Similar results will be found. Quotation marks used to find an exact match.
Publisher/imprint: Similar results will be found. Quotation marks used to find an exact match.
Published between years: “From” and “to” year dates specified.
Format: Specify format (e.g., Paperback, Hardback, etc.) of the book. Relevant values (applicable to digital books) are taken from the ONIX “product form code” and the “product form detail.”
Identifier: Search by the ISBN, OCLC, EAN, or INSI number.
Collection: Filter by the user's collections that have been created for managing display use preferences. The pulldown menu lists all collections for a given account. If no collections have been created, the only option is Default.

The user can fill out as many fields as desired in order to narrow the list of results down. If nothing is selected in a field, then that field is not narrowed at all (e.g., if no “format” is chosen, then all formats are included in the result set). Content within the drop-down lists includes Search, Format, and Collection.

Searches return similar results unless one includes quotation marks around each search term. Quotation marks ensure an “exact match.” Exact match means that the search results must contain that exact text, but may contain additional text as well. Exact matching only makes sense when there are multiple words in the search string. For example, searching for New Moon would find all books that have either New or Moon in the title (e.g. The New American Cookbook, Pale Moon), but searching for “New Moon” finds only those that have both words together, e.g. New Moon, New Moon (The Twilight Saga).

As shown, the Page 720 also includes a Secondary Navigation Bar 722. The Bar 722 includes the following choices:
Search for Book: Here, the user is on the Search for Book page so this link is selected. If on another page and the user clicks on this item, he/she is taken to this page.
Add/Import Book: Takes the user to a page where he/she can add an individual book, or import multiple books, to the Registry database.
View Last Search: This opens the user's most recent search with an updated result set. For example, if the user logged in three months ago and last searched for “Twilight” as the title, that query is stored. When this link is clicked, the result set is updated with any changes made to the database since the last time queried, as is displayed. (The actual query is stored, not the results.) If the user has never done a search, the link is deactivated.
View My Books: Navigates to a page with a list of the user's claimed books. If the user does not have any claimed books, the link is deactivated.

### Search Results

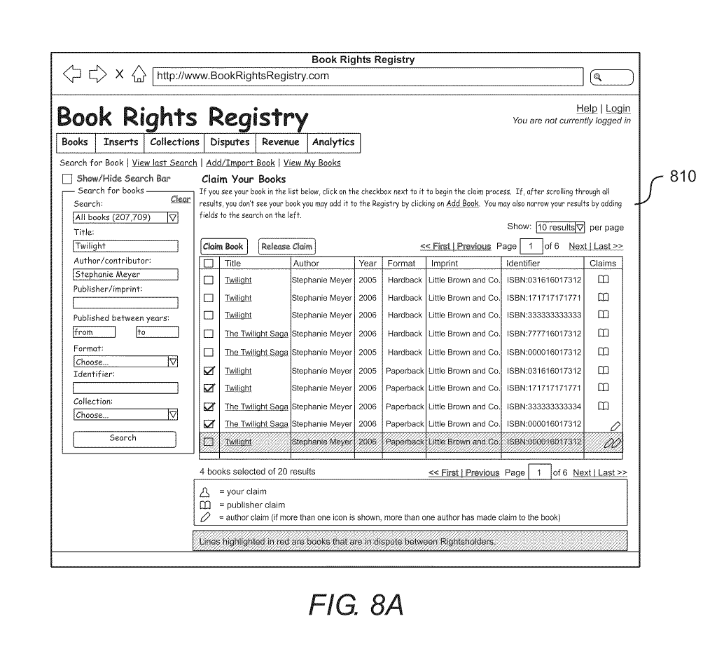

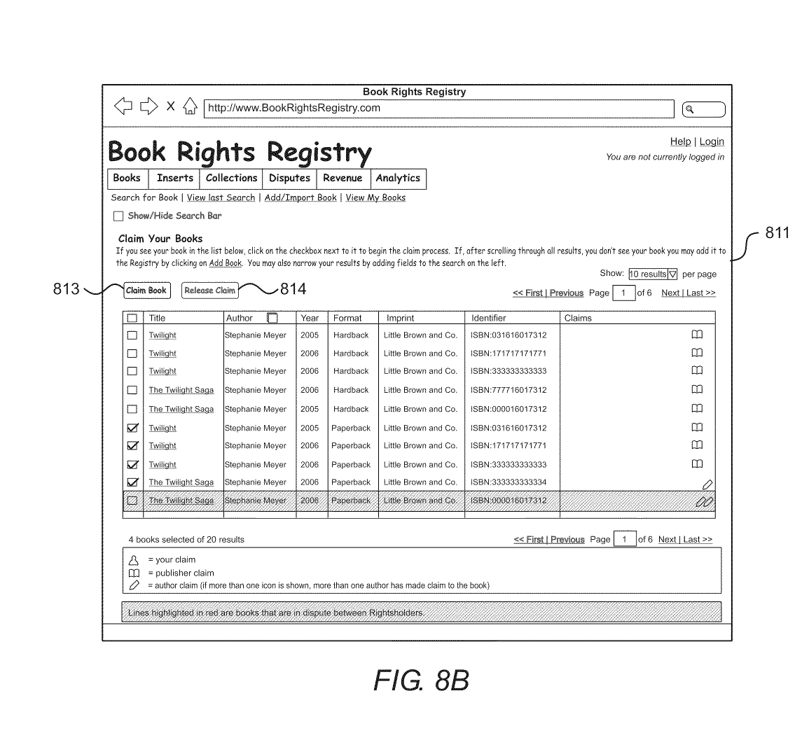

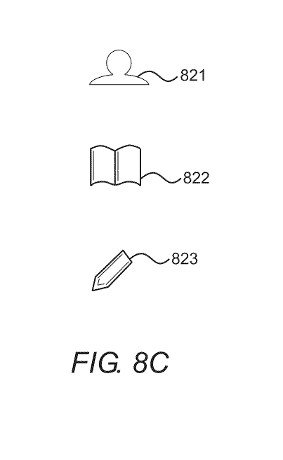

FIG. 8A is a bitmap screenshot illustrating search results (page 810) of the search started on the opening page (i.e., example above). FIG. 8B is a bitmap screenshot illustrating the search results (now shown at page 811) maximized, that is, with the Search for books panel closed. If there are matches to the search query, a list of books will be displayed on the page from which to select. From here the user can view a book's details, make and release claims, and add books to the Registry.

The list of books shown represents the registered books that currently match the search query. The list includes the following fields:
Title: The title of a given book. User may click on the title to view additional details of the book.
Author: The author, or authors, of the book. All contributing authors will be listed. The user can rollover (cursor over) the author name to view all authors if they are not all visible.
Year: The publication year of the book.
Format: The format of this book; hardback, paperback, etc.
Imprint: The imprint company name of the book.
ISBN: The International Standard Book Number for this book.
Claims: Information about the parties that have made claims for this book. Users can rollover icons to see the name of the company or person behind the claim. If there are multiple icons of one type that means that several parties have claimed the book. The icons employed, illustrated in FIG. 8C, include the following:

Icon #1 (821): Current user has made a claim to this book.

Icon #2 (821): A publisher has made a claim to this book.

Icon #3 (823): An author has made a claim to this book.

If a book is in dispute between rightsholders, it is highlighted in red. As the user selects books from the list, a count is displayed at the bottom of the page. For example, if the user has selected four books out of a total result set of 100, the text will state: 4 books selected of 100 results

Results are shown in alphabetical order by title, ignoring words such as “the” and “a” in the title. Column headers can be clicked on to order (ascending) by a specific column. This will reorder all results—not just the results shown on the screen at the time. For example, if the user clicks on Author, the results will be reordered in alphabetical order by author last name. The user can click on the column header again to order in descending value. The user can go directly to a specific page in the results set by typing in the page number in the box on the top, right side of the list or the bottom right side of the list. The user can page through the results set by clicking on the links First, Previous, Next or Last. If the links are not relevant, they are deactivated. (For example, if the user is on the first screen, both First and Previous will be inactive.)

As shown, the page 811 includes a Claim Book button 813 and a Release Claim button 814. The user can select books from the result set and then click on Claim Book button 813 to invoke the process of making a formal claim for a book, or books. If no books are selected, the button is inactive. The user can select books from the result set and then click on Release Claim button 814 to release a book that has been claimed in the past. If the user has not claimed any books, the button is inactive.

### Claiming a Book

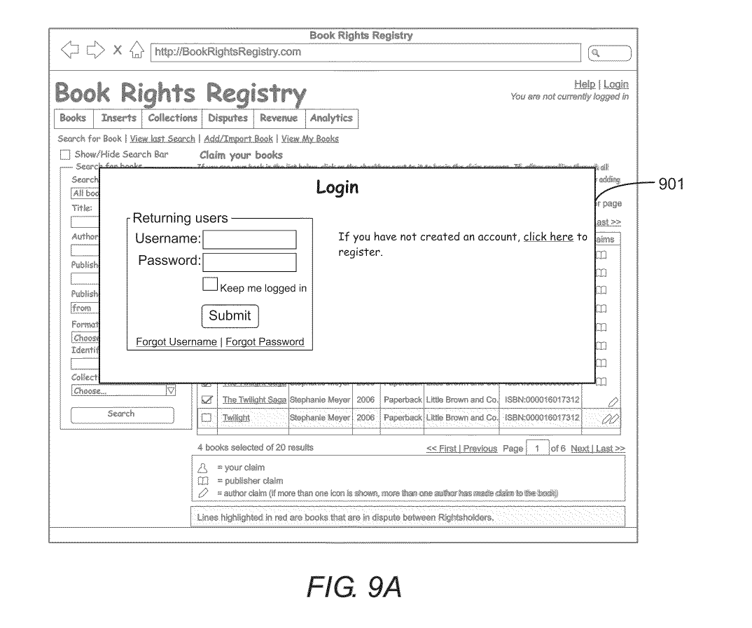

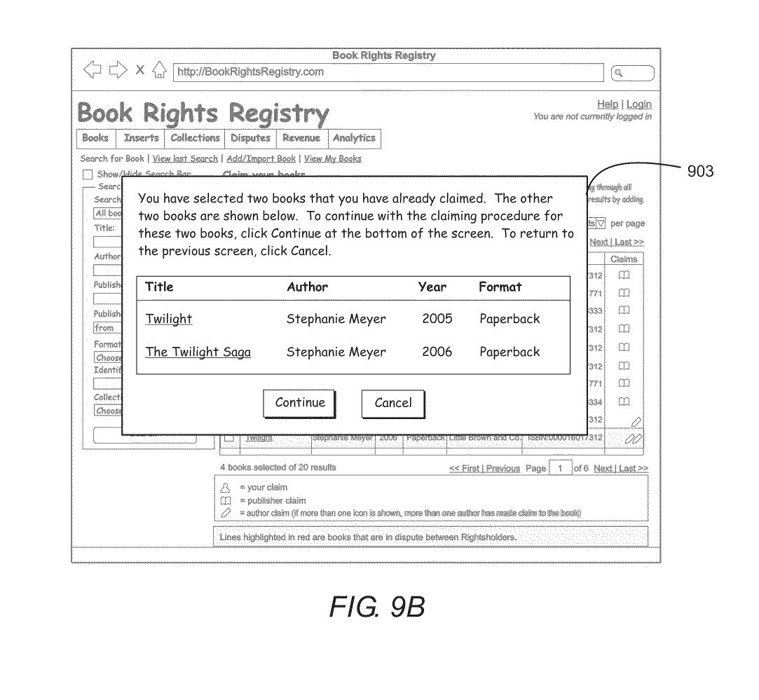

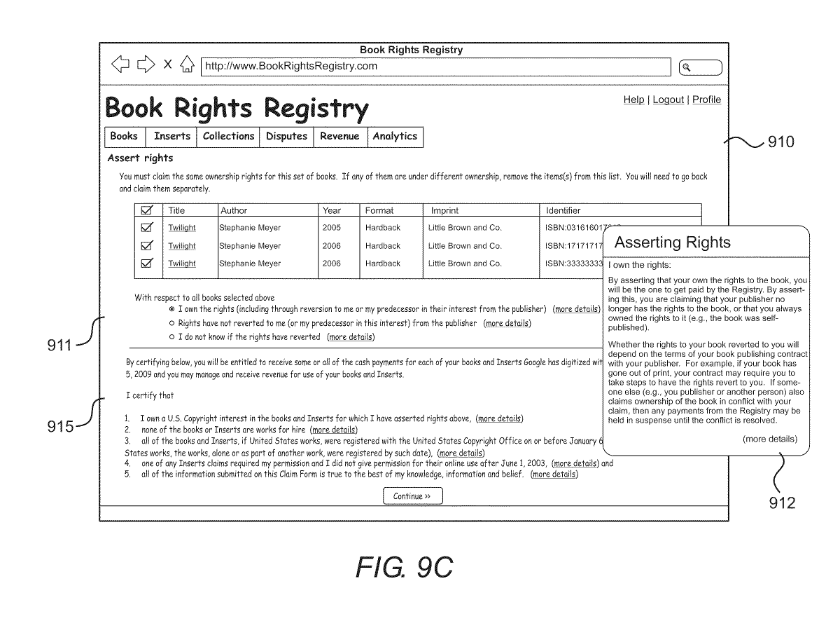

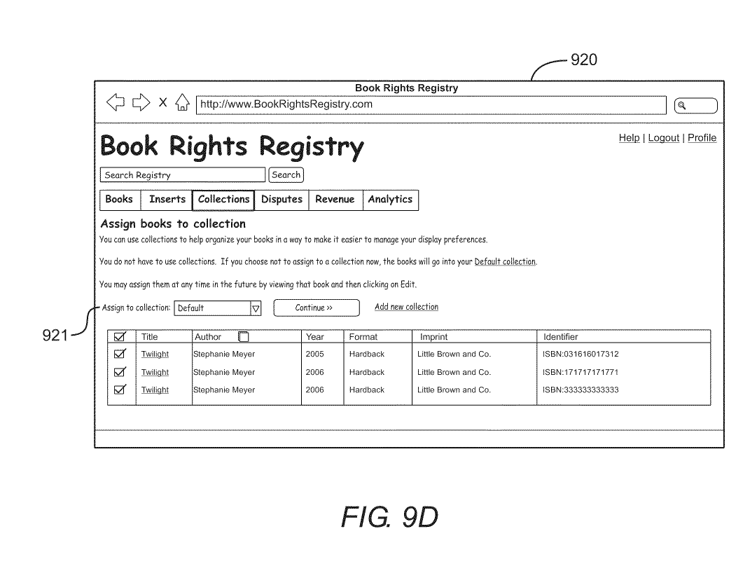

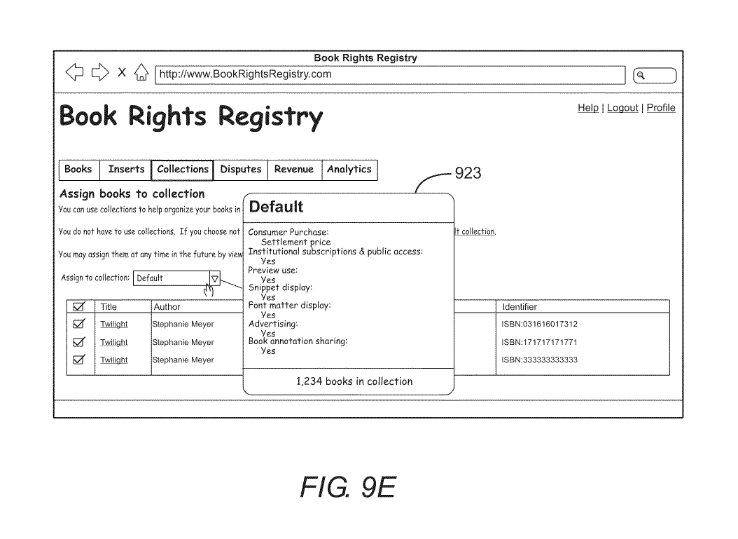

FIGS. 9A-E are bitmap screenshots illustrating the process of claiming a book. As shown in FIG. 9A, when a user tries to make a claim on a book from the results page, he or she must be logged into the BRR system. If the user is not logged in, then a pop-up screen 901 appears for login (if a returning user) or, alternatively, for sign up as a new user with the Registry. Once the user has either logged in, or registered, the system navigates to the next page in the process, Verification.

FIG. 9B illustrates this verification, which occurs via a Verification popup 903. The pop-up appears when the user attempts to make a claim on a book that he or she has already claimed in the past. In the present example (shown in the figure), the user has tried to claim four books. However, the user claimed two of those four previously, so he or she cannot reclaim the books. Instead, the pop-up shows the other two books that had not been claimed in the past. The user then has the option to either continue claiming those two books, or cancel out of the pop-up and return to the previous screen to make any changes. (The regular registration process occurs in the pop-up screen.).

Once the user has selected the book(s) that he or she wants to claim, the user is taken to an Assert rights page 910 shown in FIG. 9C, to assert legal rights. All books that the user has claimed in the current session (i.e., login session) are listed on the page. The user has the option to deselect any book that he or she does not want to claim in this session. Those books are then “released” and in order to see them again, the user must again retrieve them (e.g., via search).

The page 910 displays the following Rights options (radio buttons) 911:
“I own the rights”: The user will be the one paid by the Registry. The user has full control over the display uses for that book.
“Rights have not reverted to me . . . ”: The user is just asserting that he or she has some say in the book. For example, it could be the author of the book whereby the publisher still has rights to the book. The user has the ability to set display uses for the book, but so does the publisher. (The most restrictive use settings will prevail.)
“I do not know if the rights have reverted”: The book is treated the same as “Rights have not reverted to me.”

As shown, the page includes rollover help text 912 (by hovering over the “more details” link next to each item). The following help text is provided (“I”/“you” and “my”/“your” refer to the current user):

### I Own the Rights:

By asserting that you own the rights to the book, you will be the one to get paid by the Registry. By asserting this, you are claiming that your publisher no longer has the rights to the book, or that you always owned the rights to it (e.g., the book was self-published). Whether the rights to your book reverted to you will depend on the terms of your book publishing contract with your publisher. For example, if your book has gone out of print, your contract may require you to take steps to have the rights revert to you. If someone else (e.g., your publisher or another person) also claims ownership of the book in conflict with your claim, then any payments from the Registry may be held in suspense until the conflict is resolved.
   Rights have not Reverted to Me from the Publisher:
By asserting that the rights have not reverted to you for the book, your publisher (or the person who does own the rights) will be the one to get paid by the Registry. (You may, however, be entitled a royalty on this payment from your publisher, depending upon the terms of your book publishing contract). By making this selection, you are stating that your publisher continues to have the rights to the book (i.e., the rights have not reverted to you). Whether the rights reverted to you will depend on the terms of your contract with your publisher. For example, if your book has gone out of print, your contract may require you to take steps to have the rights revert to you.
   I do not know if the Rights have Reverted:
By asserting that you do not know whether you own the rights to the book, your publisher (or the person who does own the rights) will be the one to get paid by the Registry. (You may, however, be entitled a royalty on this payment from your publisher, depending upon the terms of your book publishing contract). By making this selection, you are stating that your publisher continues to have the rights to the book (i.e., the rights have not reverted to you). If you later discover that you do own the rights (e.g., the rights have reverted to you), then you can later claim that you do own the rights to the book, in which case, you will be the one to get paid by the Registry.

The page 910 also displays a Certification Section 915. Rollover help text is available (again, by hovering over the “more details” link next to each item). The following help text is provided (again, “I”/“you” and “my”/“your” refer to the current user):

I Own a U.S. Copyright Interest in the books to Which I have Asserted Ownership Rights:
To own a “U.S. copyright interest” in a work means to own or co-own all or a portion of the copyright in the work, or to have an exclusive license under the copyright in the work, with respect to exploiting the work in the United States for the several uses authorized by the Settlement Agreement (for example, Institutional subscriptions to, or sales to consumers of, digitized versions of the book).

### None of the Works are Works for Hire:

The term “work-for-hire” is a term used in United States copyright law, referring to a work created by an author, under an agreement with his publisher, where the publisher is considered the “author” of the work. In addition, the term also refers to a work created by an employee in the course of his employment, in which case the U.S. copyright law treats the employer as the “author” of the work. In both situations, U.S. law provides that the individual who created the work has no copyright interest in it.
By certifying that a work is not a work for hire, you are certifying that you (not someone else, such as your publisher or employer) are the legal “author” under U.S. copyright law. Authors who created a book on a work-for-hire basis have no copyright interest in the work and, therefore, should not claim those particular works.
   All of the United States Works Over Which You are Asserting Ownership Rights were Registered with the U.S. Copyright Office on or Before Jan. 5, 2009:
A work is a United States work if it meets the definition of “United States work” under the U.S. Copyright Act. See 17 U.S.C. §101. See http://www.copyright.gov/title17/92chap1.html. In general, a work is “a United States work” under the Copyright Act if; it was first published in the United States, it was first published simultaneously in the United States and a treaty party (i.e., a country with which the United States has copyright relations) that has the same or longer term of protection as the United States, it was first published simultaneously in the United States and a foreign nation that was not a treaty party, or it was first published in a foreign nation that was not a treaty party and all of the authors of the work are nationals, domiciliaries, or habitual residents of the United States. If you have questions about whether your book qualifies as a United States work, please consult legal counsel.
You may check if your work was registered with the U.S. Copyright Office on or before Jan. 5, 2009, by doing a search of copyright registrations at www.copyright.gov/records.
If your books are United States works and were not registered with the United States Copyright Office as of Jan. 5, 2009, then those books are not covered by the Settlement Agreement, and you would not be releasing any claims you may have against Google with respect to those books (i.e., you retain the right to sue Google for copyright infringement for those books).

Now the user may proceed to add the claimed book to one of the user's collections. FIG. 9D illustrates an Assign books to collection page 920. Using pulldown menu 921, the user can add selected book(s) to a particular collection. Collections are used to help manage usage rights for books at a group level, rather than at the individual book level. If there are several books that should be treated in the same manner (for example, all books within a particular character series), the user can create a collection especially for that series with the same display preferences. Preferences to a given collection automatically apply to all books within that collection.

A “Default” collection is available, in addition to any user-defined ones. A default collection is created for all accounts with the following settings:
Consumer purchase=settlement price
Institutional subscriptions and public access=yes
Preview use=yes
Snippet display=yes
Front matter display=yes
Advertising=yes
Book annotation sharing=yes
   As shown in FIG. 9E, rollover help 923 is available to show a collection's current settings. If the user does not assign a book to a collection, the book is automatically placed in the default collection. The user can make a change at any time by editing the book and assigning it to a different collection.

### Book Views

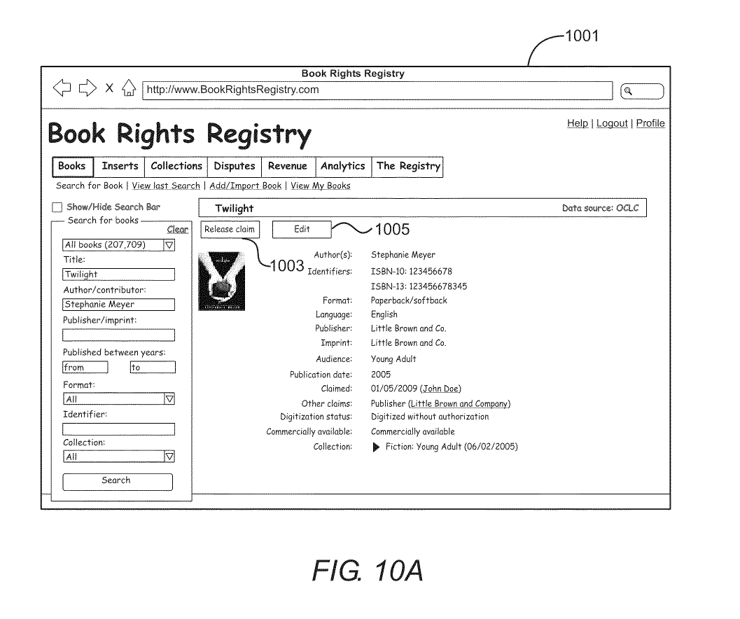

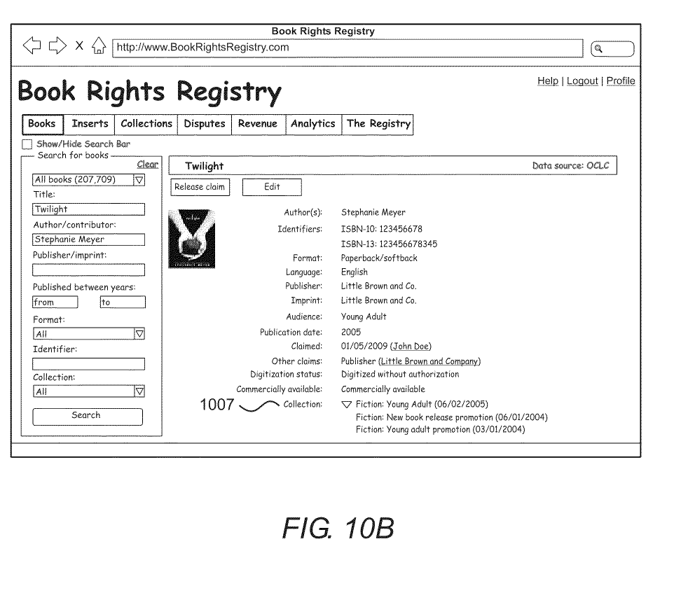

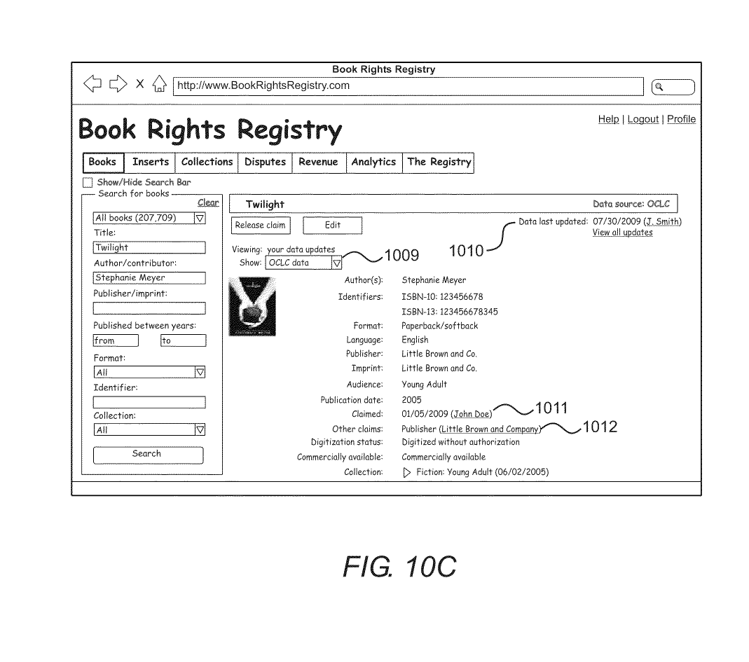

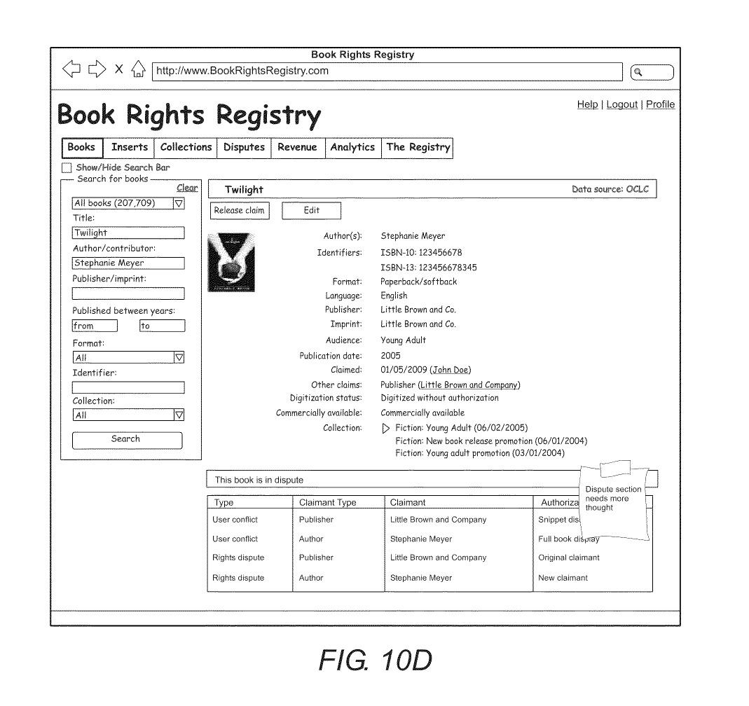

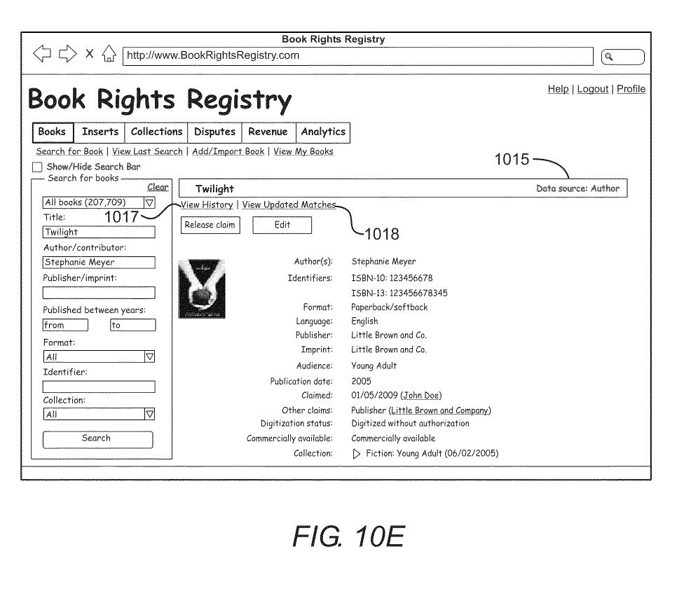

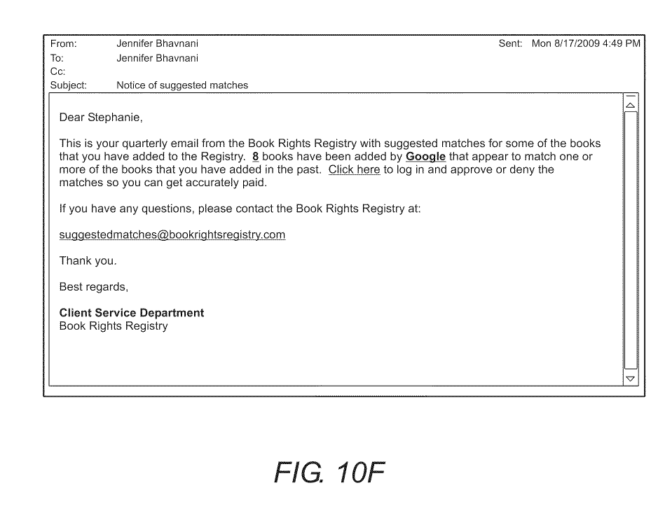

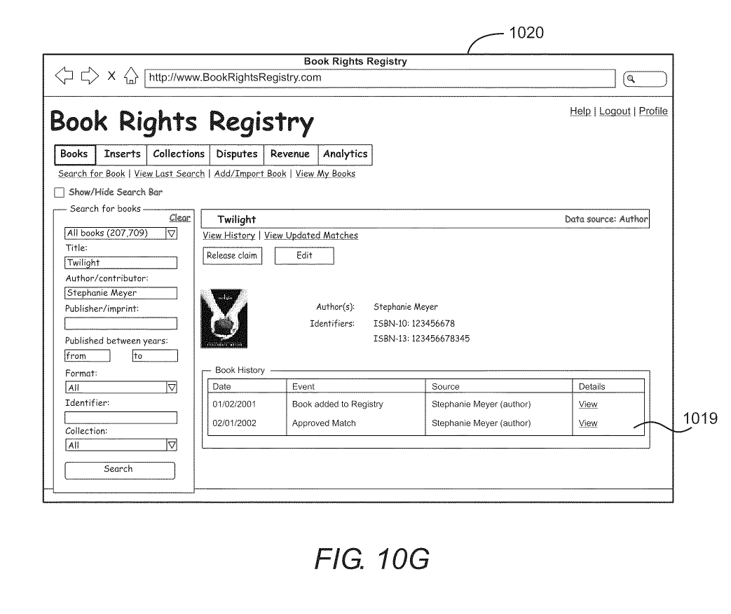

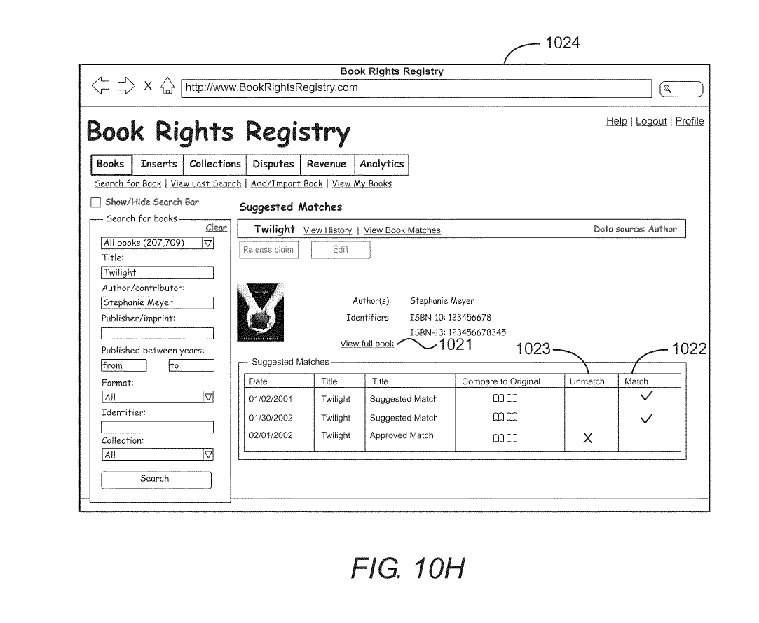

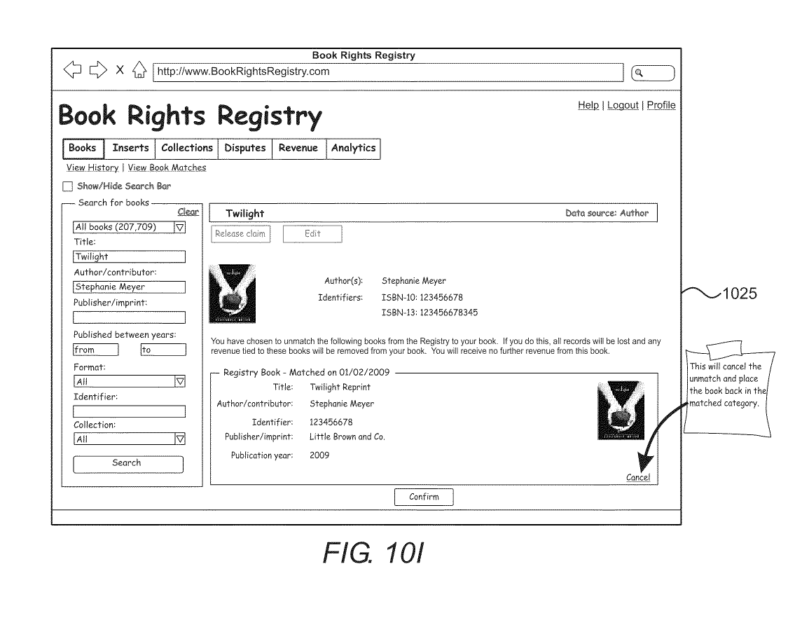

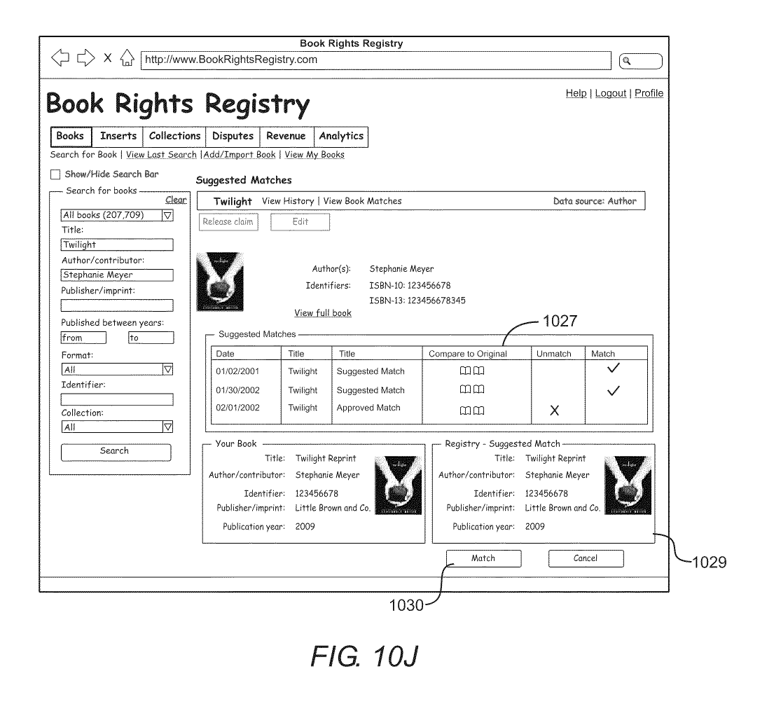

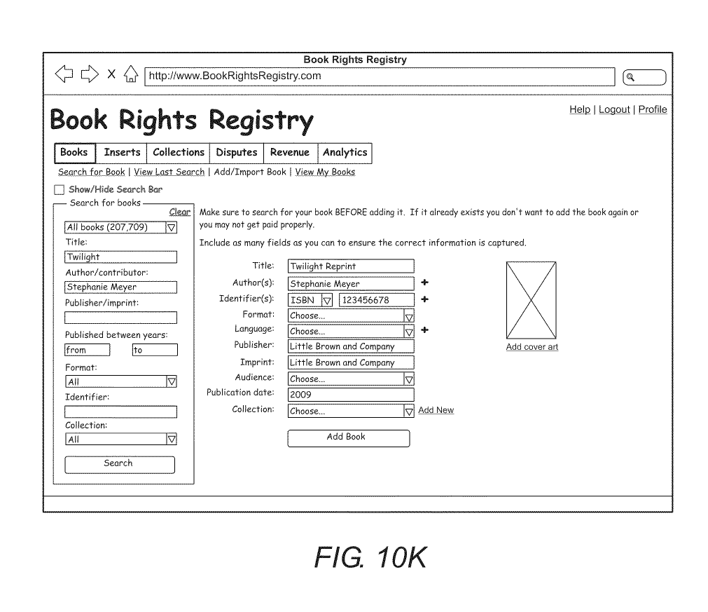

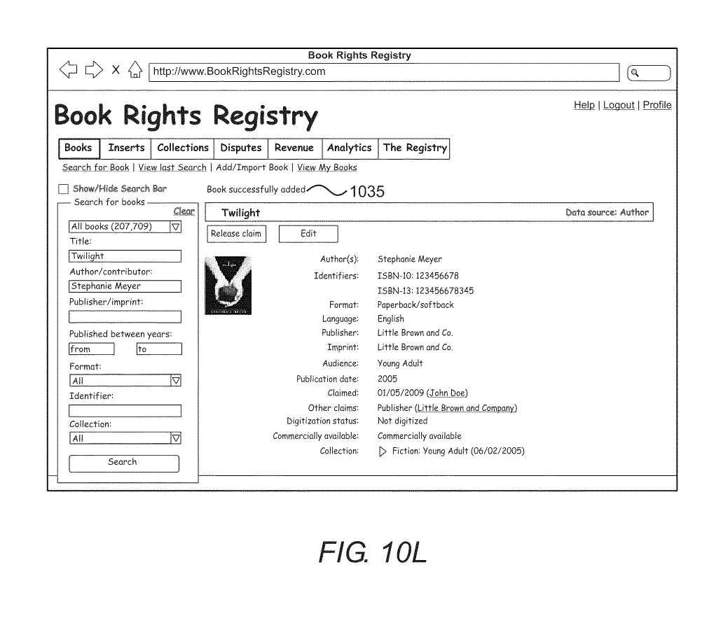

FIG. 10A is a bitmap screenshot illustrating a Book detail view or page 1001, where the user can view details of each book. The view shown is for a book where the data source is OCLC (Online Computer Library Center, see, e.g., ocic.org) and no updates have been made by the user account. Fields from outside data sources that are displayed including the following:
Author: All contributing authors are displayed in the order in which they appear in the database; multiple values allowed.
Identifiers: All identifiers from the database are listed with the identifier type first and then the value following; multiple values allowed.
Format: Value of whether this book is paperback, hardback, etc; single value.
Language: The languages present in the book; multiple values allowed.
Publisher: The publisher of this book; single value.
Imprint: The imprint for the book; single value.
Audience: The audience for this book; single value.
Publication date: Date of publication; single value.
Collection: The collection that the user assigned the book to (or Default if no collection was assigned).

Fields for data that is not from outside data source including the following:
Claimed: Date on which this book was claimed with the name of the person who claimed it.
Person's name is a link for account administrators. If the user is not an administrator, the name shows without a link. The link opens up an email box.
Other claims: Indication of who has claimed this book in addition to the current account. Company name is a link (only for account administrators). The link opens up an email box.
Digitization status: Status from Google as of “today.” Digitization means to convert a work from a hard copy format into an electronic representation. For every Principal Work, Entire Insert or Partial Insert that Google Digitized prior to the Opt-Out Deadline (Sep. 5, 2009) without the Rightsholder's authorization Google will make a Cash Payment to the Settlement Fund to be distributed to the Rightsholder. Currently the values shown on Google's site are: (1) Digitized without authorization, and (2) Not digitized, and will not be digitized on or before May 5, 2009, without authorization.
Commercial availability: Whether the book is classified as Commercially Available or not Commercially Available in the United States. This setting has an effect on whether Google is authorized to make display uses without the authorization of the Rightsholder. A book is Commercially Available if, at the time in question, the rightsholder of the book, or the rightsholder's designated agent, is offering the book for sale new through one or more then-customary channels of trade in the United States. If a book is designated as Commercially Available then Google will not be authorized to make any Display Uses of the book unless a rightsholder of the book gives express permission to do so. If a book is designated as not Commercially Available, then Google will be able to make all Display Uses of the book unless a rightsholder of the book instructs Google to exclude the book from one or more Display Uses.

The Book detail page 1001 includes two buttons: Release claim button 1003 and Edit button 1005. When the user clicks the Release claim button 1003, the system releases this account's claim on the book. A confirmation page informing the user that this will remove all history of the book and it cannot be “brought back.” The Edit button 1005 allows the user to edit the data fields. All edits are only viewable to this account. People who look up the book in the Registry will not see the updates to the data fields. As shown in FIG. 10B, the Collection field (at 1007) includes a side arrow that the user may click to show the history of the collection assignments for the book, in descending order.

FIG. 10C illustrates completion of edits. Once a book has been updated by a user, the page is changed as follows. The page is updated to add a Viewing selection 1009 that indicates which data set the user is viewing. In the screen shown in the figure, the user sees his or her data updates. Alternatively, the drop-down box enables the user to choose the OCLC data set. Data last updated section 1010 provides information about who made the last update to this book, and when the last update was made. A link is included to view the history of updates to the book. Values shown here are the date last updated and the person who made the updates, along with an email link to that person. Link 1011 (for person shown in “Claimed”) can be clicked to open an email dialog to send an email to this person. Link 1012 (for person shown in “Other Claims”) can be clicked to open an email dialog to send an email to the administrator at this company. With both links, emails sent through the system will be stored in the user's “Account” area. FIG. 10D shows the book page when the book is in dispute between Rightsholders. (Handling of disputes is discussed below.)

FIG. 10E illustrates the book page when a registered user (author) has added a book to the Registry that did not appear after performing a search for the book. Data Source field 1015 indicates which account the data came from; in this example, the author added the data. Options (aside from the Google data sources) include author, publisher, or agent. Google's data sources include OCLC and GPP (Google Partner Program). View History Link 1017 displays a View History page that allows the user to view the history of the book. View Updated Matches Link 1018 displays a View Updated Matches page that allows the user to see all matches that the Registry has found that appear to match the book. A back-end process runs on a regular basis to obtain new matches for books that were added by the user; new matches appear in the View Updated Matches page. As shown in FIG. 10F, email notification is sent to the user if something that appears to match is added.

FIG. 10G illustrates the View History page 1020. The page 1020 shows the history of the matches for a given book. In the present example, the book was added to the Registry on Jan. 2, 2001 by the author, Stephenie Meyer. On Feb. 1, 2002, the author approved a suggested match by the Registry. The View Link 1019 opens a pop-up window with the details from the corresponding line item. For example, the pop-up for the Approved Match (event item) includes the details for the book that it is matched to including the following information: Author, Title, ISBN, Format, Language, Publisher, Imprint, and Date added to Registry. FIG. 10H illustrates a Suggested Matches page 1024 providing a view for suggested matches from the Registry. The page 1024 shows the suggested matches for a book that has been added by a user. Suggested book matches come from Google adding more books to the database. As new books are added to the Google database, they are compared to the books that have been added by individual users. If there appears to be a match, the book(s) are listed on this page for the user to evaluate. The Release Claim and Edit buttons are inactive on this page to keep the user focused on going through the matching process.

Basic book information is shown at the top of the screen to help avoid cluttering the page with too much information. However, if the user clicks on View Full Book Link 1021, the remaining book details are shown above the Suggested Matches box. Actions that a user can take on this page include:
Compare the suggested match to the user-added book, in a side-by-side view;
Un-match any matches that had been made previously; and
Match a suggested match to the user-added book.

If the user agrees that a match has been found, he or she can click on the check mark in the “Match” column 1022. This action will link the books together, with that user as a Rightsholder of the book. If the user clicks on the “x” in the “Un-match” column 1023, the user is sent to a confirmation page 1025, shown in FIG. 10I, asking the user to confirm the un-match. Once the book is un-matched, that user will no longer be a Rightsholder for the book and the history behind the matched book will be removed.

As illustrated in FIG. 10J, if the user clicks on the book icons under the “Compare to Original” column 1027 the comparison will show up below the Suggested Matches box, at location 1029. The user can then either cancel out of that view and go back to the “View Suggested Matches” page, or can approve that book for matching by clicking on Match button 1030.

FIG. 10K illustrates the user interface for adding a book that is not in the Registry (e.g., when not found during a search). The user is encouraged to search the database before adding a book to avoid unnecessary duplicate entries. The user must be logged in to add a book to the Registry. Once a user submits the book, an email is sent to the Registry and to Google, and the book is added to the Registry administration site and the Google administration site. The user-submitted book is not “viewable” by anyone outside of this account unless Google adds it to the Google database. A minimum of fields must be provided in order to add a book. The title, in addition to either the author or identifier, is the minimum required. If the user does not provide the minimum fields required, an error message appears on the screen: “You must provide the title, and either the author or an identifier, in order to add a book to the Registry.” Once the user submission is completed, an email is sent to the user confirming the added book; an email is sent to Google notifying them that someone has added a book, a new book is posted in the Google administration site; an email is sent to the Registry notifying them that someone has added a book, and a new book is posted in the Registry administration site.

In addition, the system runs a background process to find books that seem to match added books. When a book is found that matches the added book, the system posts the match to the user's account to the New Matches section for the book. Also, once a quarter the Registry sends an automated email to the users with a notice to check new matches, if any have been found. (The user can also check their profile area anytime for new matches.) Current rules for matching a user-added book (in order to appear as a Suggested Match), include matching by at least one of the following:
Author and title;
Title and any identifier;
Any identifier.
   As shown in FIG. 10L, after the user has submitted the book successfully, the page refreshes with the text 1035 at the top: Book Successfully Added. The data source is “Author.”

### Book Import

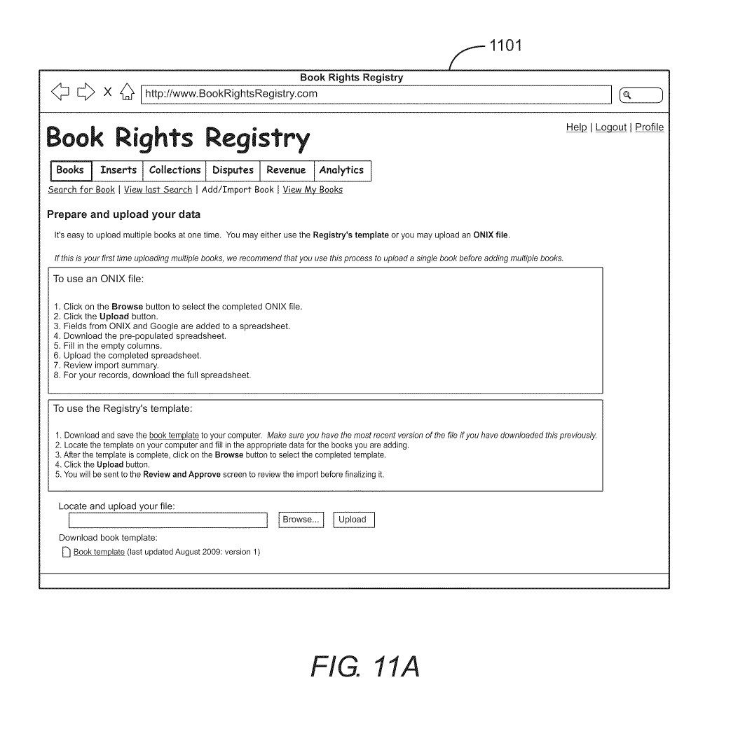

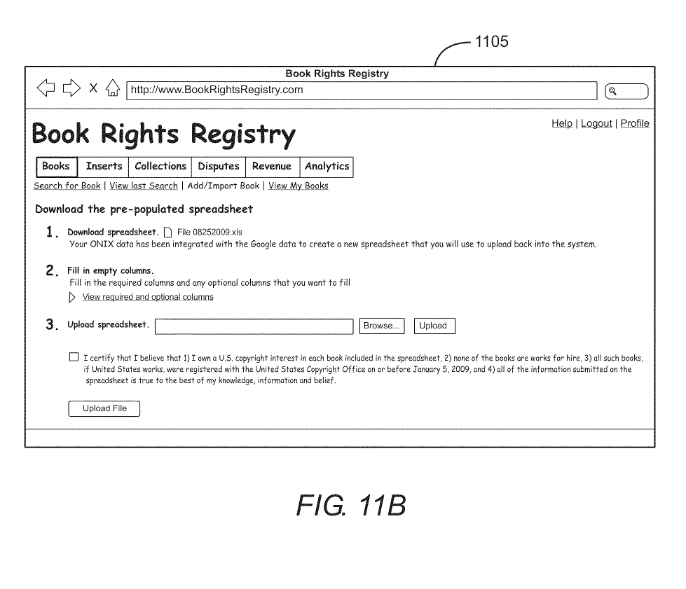

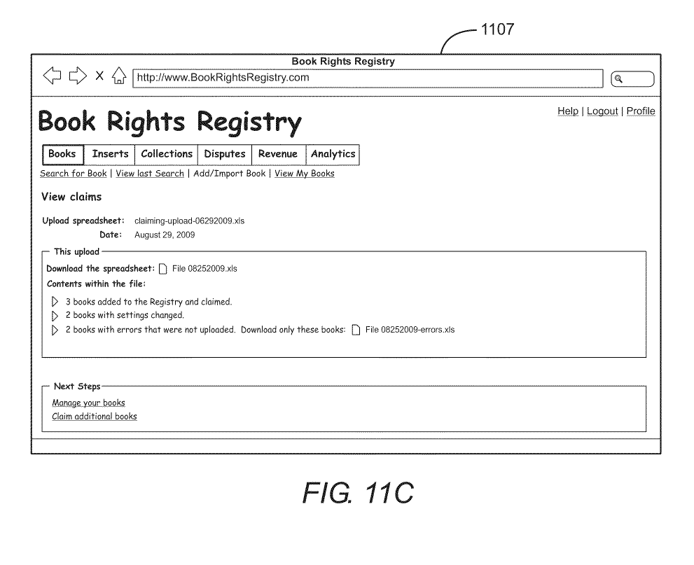

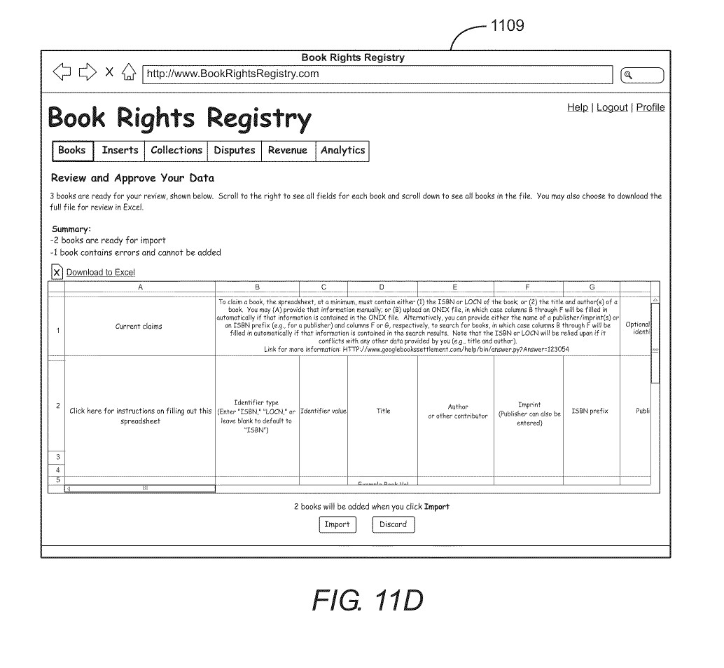

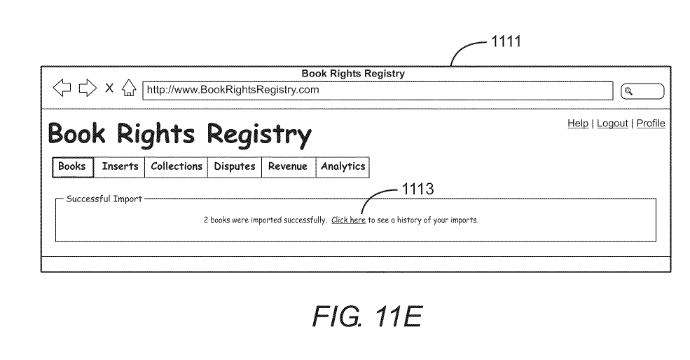

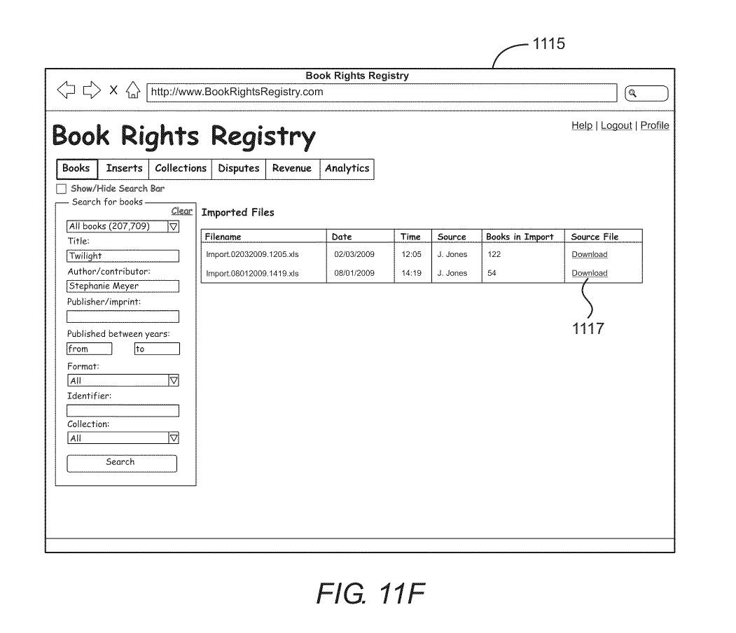

FIGS. 11A-F illustrate the process of importing book data. Prepare and upload page 1101, shown by the bitmap screenshot of FIG. 11A, serves two functions: enable a user to upload multiple books that are not already in the Registry, and enable a user to claim multiple books that are already in the Registry. Typically, a publisher would use this to claim many books at one time, instead of claiming each book one at a time in the system. The user can upload an ONIX file of books, and/or the user can manually enter information about books in a spreadsheet. An ONIX (ONline Information eXchange) file is an XML based file that is structured accordingly to an international standard for representing and communicating book industry product information in electronic form. ONIX is developed and maintained by EDItEUR jointly with Book Industry Communication (UK) and the Book Industry Study Group (US). As shown in FIG. 11B, an uploaded ONIX file can be integrated with Google data to create a new pre-populated spreadsheet that the user downloads (from Page 1105), edits/completes, and uploads (again, from Page 1105).

The process proceeds as follows (“you”/“your” refer to the current user):
1. Upload the ONIX file
2. The following columns on the spreadsheet will be filled in automatically to the extent the information is contained in the ONIX file:
   a. Column B: Identifier type
   b. Column C: Identifier value
   c. Column D: Title
   d. Column E: Author or other contributor
   e. Column F: Imprint
   f. Column H: Publication year
   g. Column L: Work for hire
   h. Column S: Do you consider this book Commercially Available?
3. The following columns will be filled in based on information provided by Google:
   a. Column P: Digitization status (book has been digitized or may be digitized on or before May 5, 2009 without authorization)
   b. Column Q: Is the book currently designated as “Commercially Available” under the Settlement?
   c. Column R: Conflict: An “X” will appear in this column if Google's and your information regarding the status of a book as Commercially Available is conflicting. Note that this column can only be filled in if you provide the information requested in Column S.
   d. Note: When you upload an ONIX file, by being provided with a pre-populated spreadsheet with the information in Columns P and Q, you are attesting to the following statement: “This ONIX file consists of information kept in the account holder's ordinary course of business about one or more of the account holder's books.”
4. Download the pre-populated spreadsheet by following the instructions on the next screen.
5. To claim books, publisher claimants is required to:
   a. Fill in the following columns if they are empty:
      Either
         i. Column C: Identifier value; or
         ii. Column D: Title and Column E: Author or other contributor
   b. Fill in or leave blank Column L: Is this book a work for hire? If you leave this column blank, the book will be treated as not a work for hire.
   c. Fill in one of the following two columns:
      i. Column M: Highly Confident that rights have not reverted; or
   ii. Column N: Confident that rights have not reverted
6. To claim books, claimants other than publishers (authors and agents) is required to:
   a. Fill in the following columns if they are empty:
      Either
         i. Column C: Identifier value; or
         ii. Column D: Title and Column E: Author or other contributor
   b. Fill in Column 0: Have the rights reverted to you, your predecessor in interest, or your client from the publisher?
7. You may fill in any of the columns labeled as optional at this time.
8. Upload the completed spreadsheet.
9. Check the certification at the bottom of that page.
10. Click the button marked “Upload and claim books.”
11. Review the confirmation screen. You will receive further instructions regarding books that could not be claimed.
   FIG. 11C illustrates a summary page 1107, indicating the books/claims just imported.

The process for starting from a blank template is similar. It proceeds as follows (again, “you”/“your” refer to the current user):
1. Download a blank template
2. To claim books, publisher claimants is required to:
   a. Fill in the following columns:
      Either
         i. Column C: Identifier value; or
         ii. Column D: Title and Column E: Author or other contributor
   b. Fill in or leave blank Column L: Is this book a work for hire? If you leave this column blank, the book will be treated as not a work for hire.
   c. Fill in one of the following two columns:
      i. Column M: Highly Confident that rights have not reverted; or
      ii. Column N: Confident that rights have not reverted
3. To claim books, claimants other than publishers (authors and agents) must:
   a. Fill in the following columns:
      Either
         i. Column C: Identifier value; or
         ii. Column D: Title and Column E: Author or other contributor
   b. Fill in Column 0: Have the rights reverted to you, your predecessor in interest, or your client from the publisher?
4. You may fill in any of the columns labeled as optional at this time, if you have information sufficient to fill out those columns.
5. Upload the completed spreadsheet.
6. Check the certification at the bottom of that page.
7. Click the button marked “Upload and claim books.”
8. Review the presented confirmation screen (screen 1109, FIG. 11D). You will receive further instructions regarding books that could not be claimed. (see below screen shot)
   Once the import is complete, the user is presented with the confirmation screen (screen 1111, FIG. 11E). The user can then view the history of all imports by clicking on the Link 1113 provided. As shown in FIG. 11F, the system provides an Imported Files page 1115, which displays a list of all imported files. User can click on the Download Link (e.g., Link 1117) next to a particular import to see the original source file.

### Binaries Import

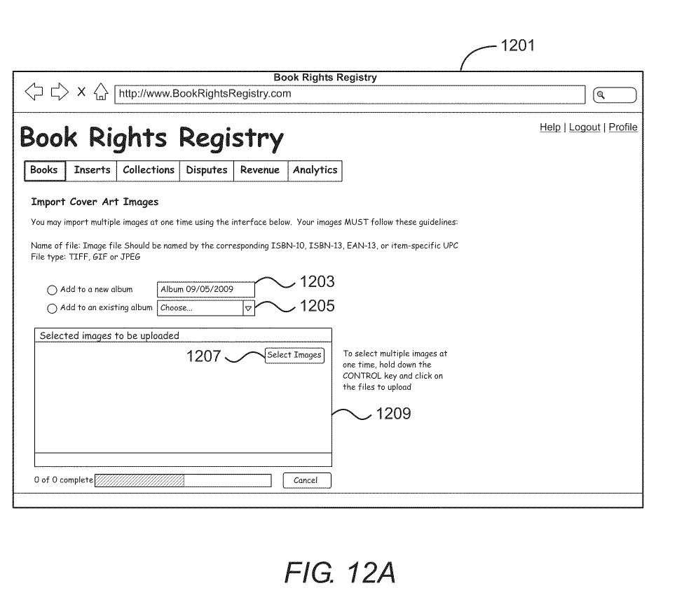

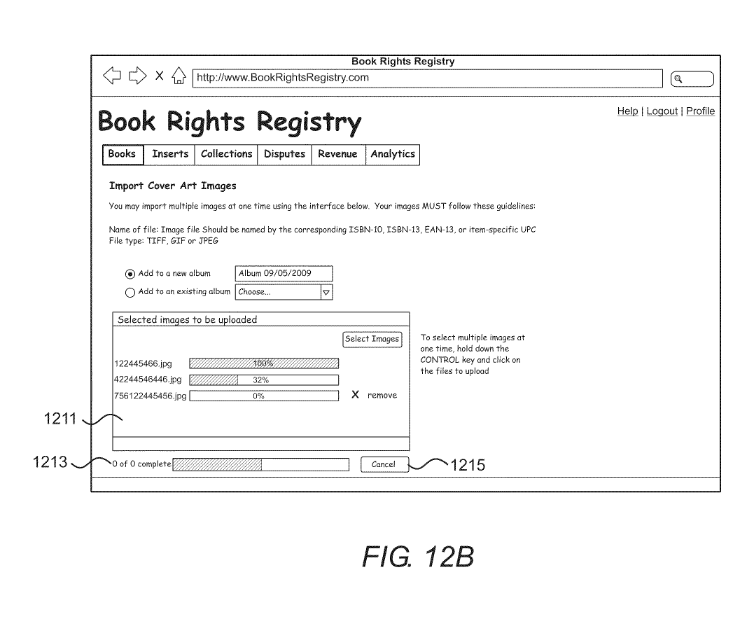

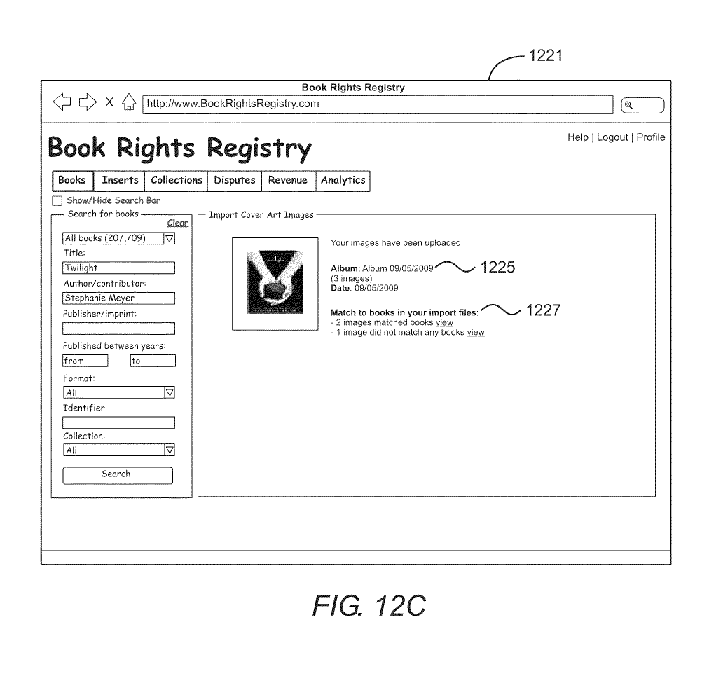

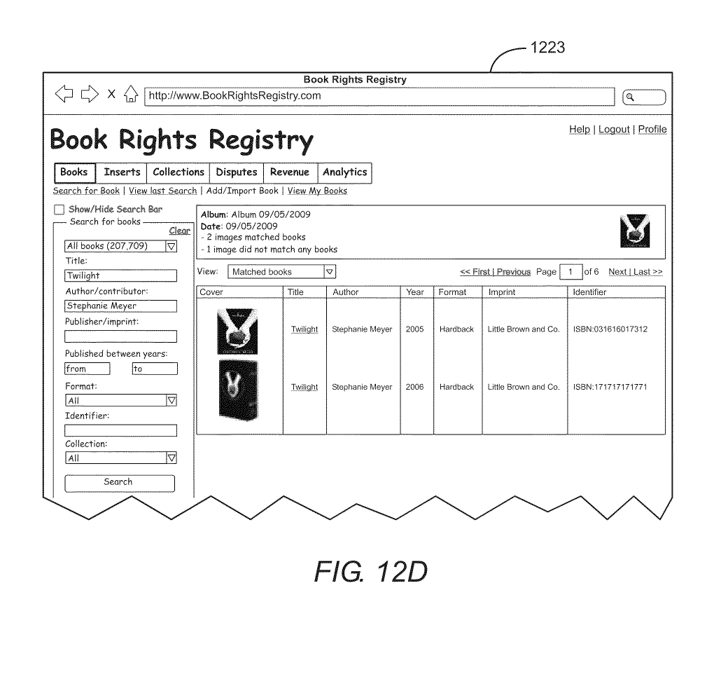

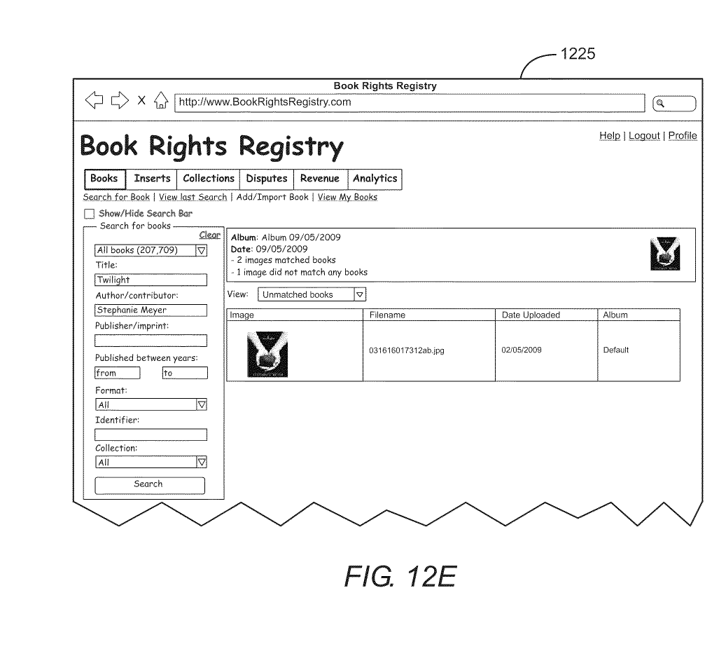

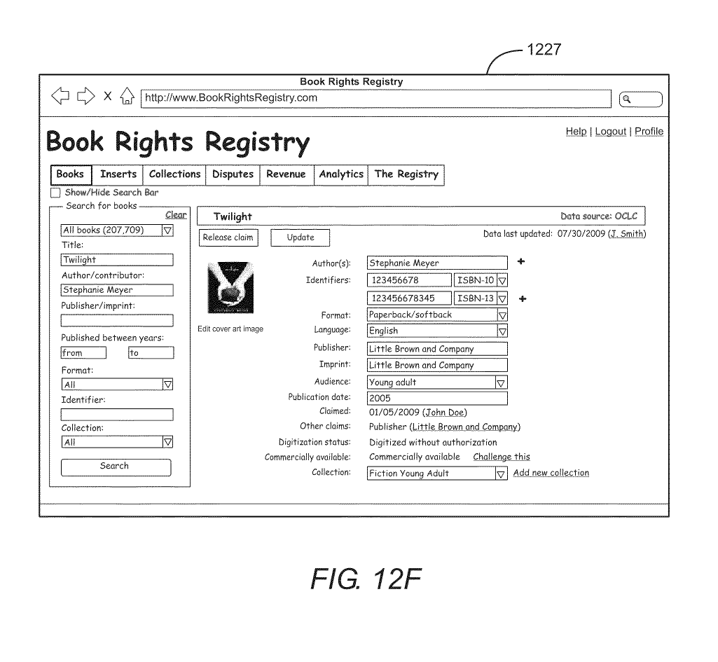

FIGS. 12A-F illustrate the process of importing a “binary” (i.e., electronic file) that is to be associated with a registered book. The imported binary may include any electronic file that is desired to be associated with a given registered work (e.g., registered book), including for example an e-book file (e.g., Amazon Kindle, HTML, PostScript, Microsoft LIT, Portable Document Format (PDF), Palm Digital Media, Open eBook, Mobipocket, etc.), ASCII text file, image (e.g., .JPG) file, audio file (e.g., audio book, ringtone, soundtrack, etc.), video file, promotional file/excerpt, software, or the like. For clarity of discussion, the following will focus on the process of importing an image file (e.g., JPG) for use as cover art for a registered book. Those skilled in the art, enabled by the teachings herein, will appreciate that the aforementioned process may easily be adapted to accommodate importation of other binaries that are desired to be associated with a given registered work.

Import Cover Art Images Page 1201, shown by the bitmap screenshot of FIG. 12A, allows the user to add multiple images at one time for a group of books via a simplified interface. Preferably, one main cover art image is specified per book (to avoid confusion). If more than one image is uploaded for a book, only the first one is taken. The imported file must have a type that is recognizable as an image, such as TIFF, JPEG or GIF. The file will be named based on the corresponding ID for the book; this can be done manually by the user, or in an automated manner. The user can either upload to an existing album, or can create a new album to upload to. All images in this “batch” will be uploaded into the same album. Add to a new album field 1203 is used to create a new album for this batch of images. Add to an existing album pulldown menu 1205 is used to upload the images to an album that already exists. Select images button 1207, located in the selection box 1209 below the album specification, lets the user navigate to where the images are located on his computer. The user clicks on the images to be uploaded and the images will start to upload. The status bar at the bottom shows the status of all images being uploaded. As images are uploaded, they are matched to books in the catalog.

FIG. 12B shows the page updated to indicate the status of each image and the status as a whole batch. Within the box area is a list 1211 of the images that are uploading. Each of those has a status bar next to it. A corresponding Remove button is available until the image begins upload. If the user clicks on the corresponding Remove button, that image is removed from the list to be imported. As soon as the image begins upload, the Remove button is not available for that image any longer. The status bar 1213 along the bottom is for the batch as a whole. It shows how many images have uploaded so far, out of the total amount of images uploading in this batch. The Cancel button 1215 at the bottom will cancel out of the batch of images at the point clicked on. For example, if the user clicks on cancel after one image has uploaded, then that batch will include one image. The Select Images button is still available, and the user can add more images while the others are uploading.

Once the images have uploaded completely, confirmation page 1221 is displayed, as shown in FIG. 12C. Confirmation page 1221 includes a summary of that album. Album information field 1225 displays the name of the album, the number of images within the album, and the date the album was created. Image mapping information field 1227 lists the number of images that matched to books that exist in the “catalog,” and lists the number of images that did not match to a book. The first View link takes the user to page 1223 (FIG. 12D), which shows the images along with the books they are matched to. The second View link takes the user to page 1225 (FIG. 12E), which shows the image data that did not match to a book in the system. As new books are added to the user's catalog, the system checks to see if there are any images that will match to them. If a book is added and an image matches it, that image is then displayed with the book for that account. Images are not displayed to the public unless Google adds them to its database.

Finally, FIG. 12F illustrates the final data (page 1227) for the registered book in the example. As shown the data page 1227 displays Title, Author/contributor, Identifier, Format,

Language, Publisher, Imprint, Audience, Publication date, and Collection. Updates to the data will only be reflected in that user's master account. For example, if someone at Random House makes a change to the data, only users within the Random House account will see the changes. A user at MacMillan will see what is reflected in the OCLC database only. However, updates will be sent to Google, and if the company decides to update its dataset, then the changed data will be reflected in the platform to everyone. Users can only edit data for books that they have claimed.

### Detailed Internal Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

Registering/Claiming a Work

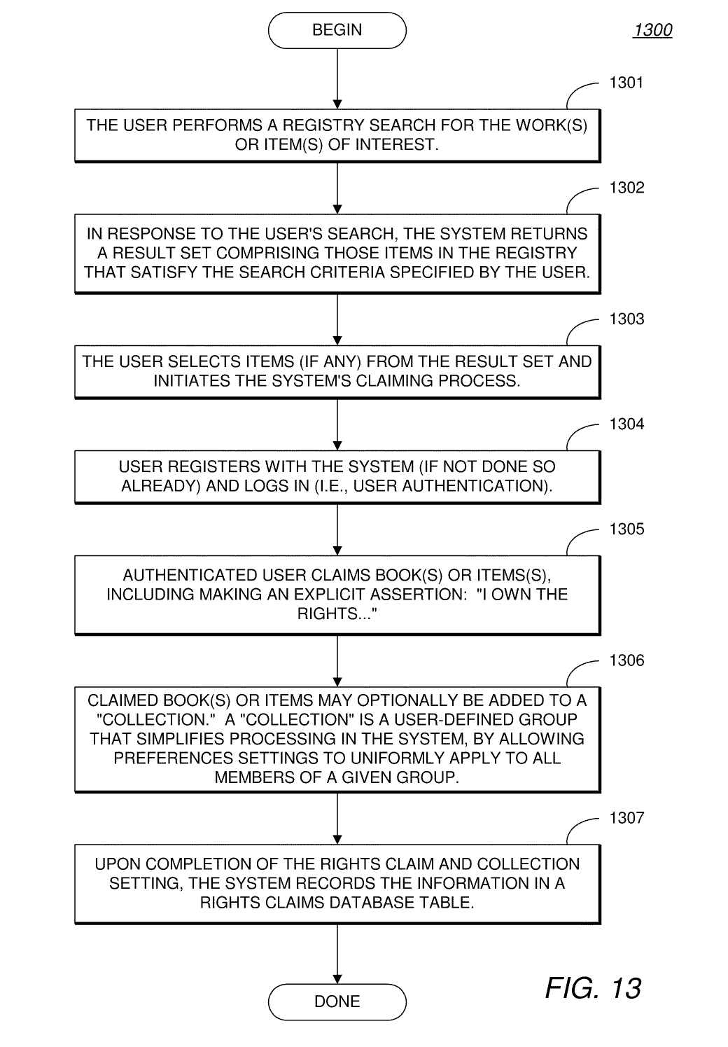

FIG. 13 is a high-level block diagram illustrating a method 1300 for registering/claiming a book using the Book Rights Registry system and platform of the present invention. As an initial step, the user performs a Registry search (Search the Registry 611, FIG. 6B) for the work(s) or item(s) of interest, at step 1301. The initial search is open to the public (i.e., public page, for searching the Registry), and thus does not require the user to login or even be registered. The user can enter one or more search fields (Search for books panel 721, FIG. 7B), including title, author, publisher, year, and the like. In response to the user's search request, the system returns a result set, at step 1302. The result set includes those items in the Registry that satisfy the search criteria specified by the user. For example, an author can enter his or her name to find that author's books listed in the registry. The user can now select items (if any) from the result set and initiate the system's claiming process (Claim Your Books page 810, FIG. 8A), as indicated at step 1303. (If desired, the user can optionally drill down into each individual item to uncover additional details, before initiating a claim.)

The process of claiming a book proceeds as follows. To claim a book, the user must be registered with the system and logged in (i.e., user authentication), as indicated at step 1304. (Users who fail authentication cannot claim rights.) During registration, the user indicates what type of rights the user holds: author (author's rights), publisher (publisher's rights), or author's agent (rights delegated to agent). To claim the selected book(s), at step 1305 the authenticated user makes an explicit assertion: “I own the rights . . . ” (Asserting Rights 912, FIG. 9C). After the user has claimed the book(s), he or she may add it/them to a “collection,” at step 1306. A “collection” is a user-defined group that simplifies processing in the system, by allowing preferences settings to uniformly apply to all members of a given group. The user defines a particular collection of books to simplify the task of setting display preferences and usage rights. For example, an author user can define one collection as a previews only collection, and define another collection as a free download collection. In this manner, the user can manage preferences at the collection level, thus simplifying overall management of claimed books. Upon completion of the rights claim and collection setting, the system records the information in a rights claims database table, as indicated at step 1307. Since multiple users (i.e., authors and publishers) may claim a given book, the database supports a many-to-one relationship between claimants and claimed books or items. Once a given book has been claimed and (optionally) categorized into a collection, both the claim and the category can serve as additional search criteria for queries.

If the user is unable to locate the book or item of interest (at step 1301), the user can manually add those books and items to the registry. In such a case, the user invokes an “Add Book” command and furnishes the necessary information. The user can perform this step in batch mode by uploading a file containing the information for a multitude of such items. As previously described, the data source for the registered book is set to “Author” (instead of Google). After adding a book(s), the user may claim rights in the book (i.e., invoking the method 1300).

Payment Distribution

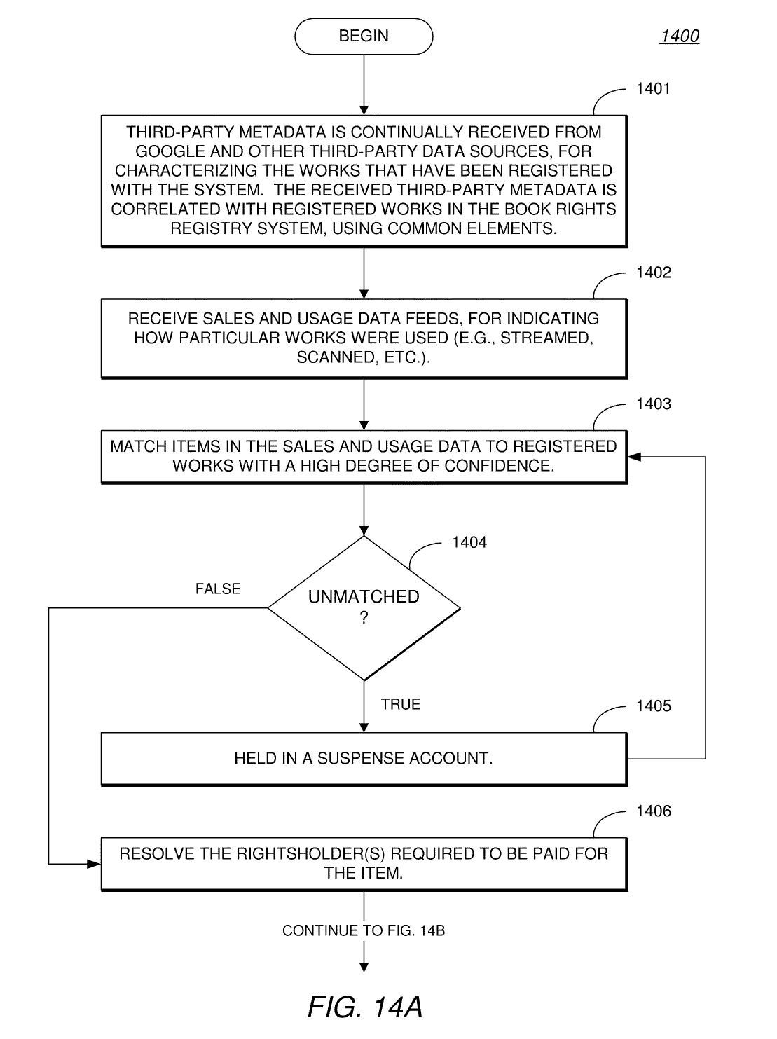

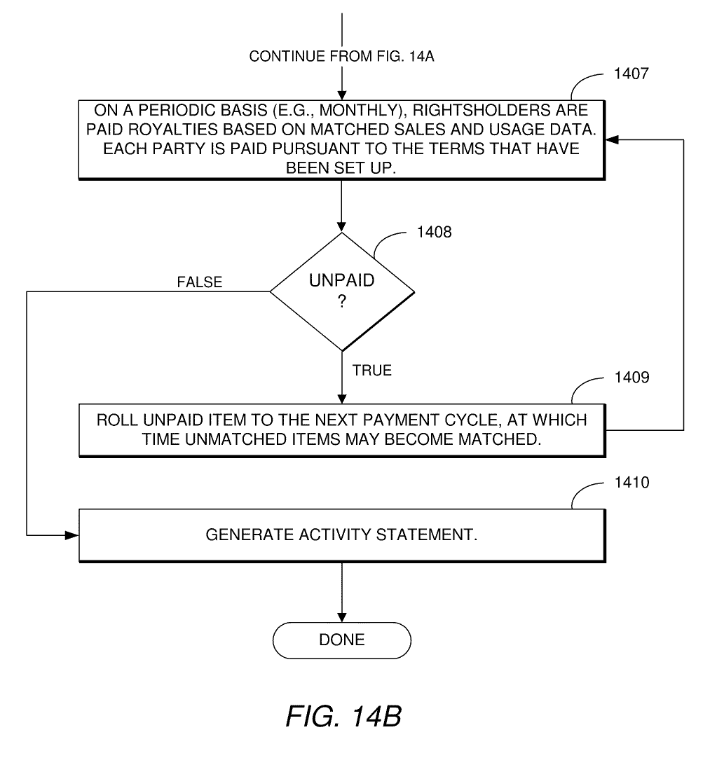

FIGS. 14A-B comprise a high-level block diagram illustrating a method 1400 for processing and distributing payments for books and other items registered with the Book Rights Registry system of the present invention. As an initial step, third-party metadata is continually received (e.g., in real time or by periodic updates) from Google and other third-party data sources, for characterizing the works (i.e., books and inserts) that have been registered with the system, as indicated at step 1401. The received third-party metadata is correlated with registered works in the book rights registry system of the present invention, using common elements (e.g., ISBN and Library of Congress numbers) present in both. This allows the system to correlate registered works with identifiers from other systems (e.g., correlate a registered book by Google ID). Techniques for parsing and processing metadata are disclosed in detail in currently-pending, commonly-owned application Ser. No. 12/410,420 (Docket No. RS/0003.01), filed Mar. 24, 2009, entitled “Digital Content Management System with Methodologies for Lifecycle Management of Digital Content,” the disclosure of which is incorporated by reference herein.

The system also receives sales and usage data feeds, at step 1402, for indicating how particular works (e.g., books or inserts) were used (e.g., streamed, scanned, etc.). Given the sales and usage data and given the ability to correlate items with third-party systems, the system may now match items in the sales and usage data to registered works with a high degree of confidence, as indicated at step 1403. The actual matching may proceed using the matching technique described in detail in currently-pending, commonly-owned application Ser. No. 11/671,220 (Docket No. RS/0001.01), filed Feb. 5, 2007, entitled “Web-based System Providing Royalty Processing and Reporting Services,” the disclosure of which is incorporated by reference herein. Any unmatched items (tested at step 1404), may be held in a suspense account at step 1405. (Items held in suspense are available to the system's administrative users for further review and processing.) Once the match has occurred for a given item, the system may resolve the rightsholder(s) required to be paid for the item, as indicated at step 1406.

On a periodic basis (e.g., monthly), rightsholders are paid royalties based on matched sales and usage data and the payment/royalty terms that have been set up. In an exemplary embodiment, distribution of payments occurs as follows:
In-Print Books. Remitted by the Registry to the Publisher and flow through the royalty statements of the Publisher.
Out-of-Print Books.
   Where the rights have reverted to the Author or are Author-Controlled, the Registry will remit one hundred percent (100%) of such revenues to the Author.
   Where book is work-for-hire, the Registry will remit one hundred percent (100%) of such revenues to the Publisher.
   For Out-of-Print Books other than those above, the Registry will separately remit payment to both the Author and the Publisher as follows:
      Publication Year prior to 1987, the Registry will pay out sixty-five percent (65%) of such revenues to the Author and thirty-five percent (35%) to the Publisher.
      Publication Year during or after 1987, the Registry will pay out fifty percent (50%) of such revenues to the Author and fifty percent (50%) to the Publisher.
         Unpaid items (e.g., disputed items), tested at step 1408, roll to the next payment cycle, as indicated at step 1409, at which time the items may become payable (as a result of dispute resolution). Finally, as step 1410, an activity statement is generated. The activity statement indicates, for instance, the usage type (e.g., 39 downloads to mobile devices, 25 downloads to browsers, etc.).

Disputes

Occasionally an item may be in dispute. Possible disputes includes: Disputes between Rightsholders, Claimant-Registry challenges, and Google-Claimant challenge. Disputes between Rightsholders arise when the various Rightsholders for a single book are not in agreement. These can be between an author and a publisher or between non-publisher rightsholders (co-authors and heirs). Two variations of this kind of dispute include:
a. Rights Disputes: Disputes between Rightsholders regarding who has copyright ownership in a book (as related to payments)
b. “Permitted Use” Conflicts: Disputes between Rightsholders regarding display uses

Claimant-Registry challenges occur when the Registry challenges the identity of a claimant. The Claimant may challenge (pursuant to Dispute Resolution procedures) any Registry decision not to validate an asserted claim. Google-Claimant challenges are ones made by Google. To deter and discover fraud, mistake, intentional misconduct or negligence by Claimants in submitting Claim Forms, Google may challenge whether a Claimant is the proper Rightsholder of the Book or Insert (esp. in cases where the Claimant has requested Cash Payments or Removal).

Certain disputes may be resolved by the system in an automated fashion, as follows.
Permitted uses for In-Print Books: both an author and the publisher will be considered a Rightsholder for removal or exclusion.
   Conflicting directions: If the Author and the Publisher of a Book issue conflicting directions to the Registry for an In-Print Book, the more restrictive directions as to Removal, exclusions, changes in Display Uses or levels of access will control.
   Pricing control: The Publisher has the right to determine the pricing for Consumer Purchase.
Permitted uses for Out-of-Print Books
   Where book is work-for-hire: Publisher is the rightsholder for directing everything.
   Where rights have reverted to the author: Author is the rightsholder for directing everything.
   Where rights have not reverted to author: Both author and publisher are rightsholders for directives.
      As previously noted, payments for unresolved disputes are held in a suspense account, until such time that the dispute is resolved.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A computer-implemented method for automated assertion of a claim of rights in books, the method comprising:
maintaining a publicly-searchable registry of books subject to claims by rightsholders;
receiving user input allowing a user to select a book from the registry that the user wishes to assert a claim of rights in;
displaying a list representing rights that can be claimed by rightsholders for the selected book;
receiving input from the user for asserting a claim of rights for the selected book; and
electronically storing information about the asserted claim of rights, for facilitating automated payments to the user in connection with royalties earned for the selected book.

2. The method of claim 1, further comprising:
before allowing the user to assert a claim of rights, requiring the user to be registered.

3. The method of claim 1, wherein said list includes an assertion of a claim of full rights.

4. The method of claim 1, wherein said list includes an assertion indicating whether rights have reverted to the user.

5. The method of claim 1, further comprising:
after the user has asserted a claim of rights, controlling how the selected book is displayed in the publicly-searchable registry of books based on display preferences specified by the user.

6. The method of claim 1, further comprising:
requiring the user to specify a user type, of either an author or a publisher.

7. The method of claim 1, further comprising:
after the user has asserted a claim of rights, adding the selected book to a user-defined collection.

8. The method of claim 7, further comprising:
setting display preferences on a per collection basis.

9. The method of claim 1, further comprising:
if the selected book did not already exist in the registry, receiving user input for adding the book to the registry.

10. The method of claim 1, wherein multiple books can be selected by the user, for allowing the user to assert a claim of rights to multiple books simultaneously.

11. A system for automated assertion of a claim of rights in books comprising:
a publicly-searchable registry of books subject to claims by rightsholders;
a selection module for allowing a user to select a book from the registry that the user wishes to assert a claim of rights in;
a display module for displaying a list representing rights that can be claimed by rightsholders for the selected book;
an assertion module for receiving input from the user for asserting a claim of rights for the selected book; and
a database storing information about the asserted claim of rights, for facilitating automated payments to the user in connection with royalties earned for the selected book.

12. The system of claim 11, further comprising:
registration module for registering users.

13. The system of claim 11, wherein said list includes an assertion of a claim of full rights.

14. The system of claim 11, wherein said list includes an assertion indicating whether rights have reverted to the user.

15. The system of claim 11, further comprising:
display preferences module for controlling how the selected book is displayed in the publicly-searchable registry of books based on display preferences specified by the user.

16. The system of claim 11, further comprising:
a module for requiring the user to specify a user type, of either an author or a publisher.

17. The system of claim 11, further comprising:
a collections module for adding the selected book to a user-defined collection.

18. The system of claim 17, further comprising:
a display preferences module for setting display preferences on a per collection basis.

19. The system of claim 11, further comprising:
an add book module for receiving user input for adding the book to the registry.

20. The system of claim 11, wherein multiple books can be selected by the user, for allowing the user to assert a claim of rights to multiple books simultaneously.
